(19) United States
(12) Patent Application Publication
(10) Pub. No.: US 2015/0099193 A1
(43) Pub. Date: Apr. 9, 2015

(54) ELECTROLYTIC SOLUTION FOR NON-AQUEOUS ENERGY STORAGE DEVICE AND LITHIUM ION SECONDARY BATTERY

(71) Applicant: Asahi Kasei Kabushiki Kaisha, Osaka-shi (JP)

(72) Inventors: Shinya Hamasaki, Chiyoda-ku (JP); Aya Inaba, Chiyoda-ku (JP); Keiko Sumino, Chiyoda-ku (JP); Yusuke Shigemori, Chiyoda-ku (JP); Gang Cheng, San Diego, CA (US); Steven S. Kaye, San Diego, CA (US); Bin Li, San Diego, CA (US)

(73) Assignee: ASAHI KASEI KABUSHIKI KAISHA, Osaka-shi (JP)

(21) Appl. No.: 14/046,028

(22) Filed: Oct. 4, 2013

(51) Int. Cl. H01M 10/0567; H01M 10/0525; H01M 4/50; H01M 4/505; H01M 4/525; H01M 4/52; H01M 10/0569; H01M 4/131

(52) U.S. Cl. CPC H01M 10/0567; H01M 10/0569; H01M 10/0525; H01M 4/131; H01M 4/505; H01M 4/525; H01M 4/523; H01M 4/502; H01M 2300/0025; H01M 2004/028
USPC 429/338; 429/200; 429/342

(57) ABSTRACT

A lithium ion secondary battery that operates at a high voltage, has a high cycle life, and generates less gas, and an electrolytic solution for such a lithium ion secondary battery. An electrolytic solution for a non-aqueous energy storage device, comprising: a non-aqueous solvent; a lithium salt (A) having no boron atom; a predetermined lithium salt (B) containing a boron atom; and a compound (C) in which at least one of hydrogen atoms in an acid selected from the group consisting of proton acids having a phosphorus atom and/or a boron atom, sulfonic acids, and carboxylic acids is replaced with a substituent represented by formula (3):

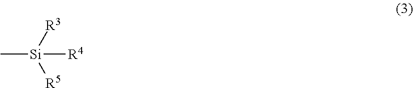

wherein R³, R⁴, and R⁵ each independently represent an organic group which has 1 to 10 carbon atoms and which may have a substituent.

### BACKGROUND OF THE INVENTION

1. Field of the Invention

The present invention relates to an electrolytic solution for a non-aqueous energy storage device and a lithium ion secondary battery using the electrolytic solution.

2. Description of the Related Art

A variety of electrochemical devices are used along with recent development of the electronic technology and increasing concerns about the environment technology. Particularly, a demand for lower energy consumption has been increased, and contributions to energy reduction have been highly expected. Lithium ion secondary batteries are a typical example of energy storage devices, and used mainly for a rechargeable battery for mobile devices in the related art, while use of the lithium ion secondary batteries as a battery for hybrid electric vehicles and electric vehicles is expected these days.

In accordance with the trend, higher battery performance is required of the lithium ion secondary batteries, and a variety of methods are studied. For example, the conventional lithium ion secondary battery that operates at a voltage of around 4 V typically uses a non-aqueous electrolyte in which a lithium salt is dissolved in a non-aqueous solvent containing a carbonate solvent as a main component (see Japanese Patent Laid-Open No. 7-006786, for example). The non-aqueous electrolyte containing a carbonate solvent has a well-balanced oxidation resistance and reduction resistance and high lithium ion conducting properties at a voltage of around 4 V.

Moreover, addition of a specific silicon compound to a non-aqueous electrolyte is proposed for the conventional lithium ion secondary battery that operates at a voltage of around 4 V (see Japanese Patent Laid-Open No. 2001-319685, for example). Use of this non-aqueous electrolyte can attain a secondary battery having high safety and the capacity that hardly reduces in initial charge and discharge.

Further, the lithium ion secondary battery needs to have a higher energy density, and to attain the higher energy density, an increased voltage of the battery is studied. To attain increased voltage of the battery, a positive electrode that operates at a high potential needs to be used. As such a positive electrode, specifically, a variety of positive electrode active materials that operate at 4.4 V (vsLi/Li⁺) or more are proposed (see National Publication of International Patent Application No. 2000-515672).

Unfortunately, if the electrolytic solutions described in Japanese Patent Laid-Open Nos. 7-006786 and 2001-319685 are used in the lithium ion secondary battery comprising a positive electrode containing a positive electrode active material that operates at a high potential of 4.4 V (vsLi/Li⁺) or more, namely, in the high voltage lithium ion secondary battery, the carbonate solvent contained in the electrolytic solution decomposes by oxidation on the surface of the positive electrode to reduce the cycle life of the battery and generate a gas in members in the battery. The reduction in the cycle life and generation of a gas in operation of the battery at the high voltage have been solved yet. An electrolytic solution allowing the improved cycle life of the high voltage lithium ion secondary battery and suppressing generation of a gas, and a lithium ion secondary battery comprising the electrolytic solution are desired.

The present invention has been made in consideration of such circumstances, and an object of the present invention is to provide a lithium ion secondary battery that operates at a high voltage, has a high cycle life, and generates less gas, and an electrolytic solution for a non-aqueous energy storage device enabling such a lithium ion secondary battery.

### SUMMARY OF THE INVENTION

As a result of intensive research for the purpose of attaining the above object, the present inventors found out that an electrolytic solution for a non-aqueous energy storage device comprising a non-aqueous solvent, a lithium salt (A) having no boron atom, a lithium salt (B) having a specific structure and a boron atom, and a compound having a specific structure can solve the problems above, and have completed the present invention.

Namely, the present invention is as follows.

[1]

An electrolytic solution for a non-aqueous energy storage device, comprising:

a non-aqueous solvent;

a lithium salt (A) having no boron atom;

a lithium salt (B) containing a boron atom represented by formula (1):

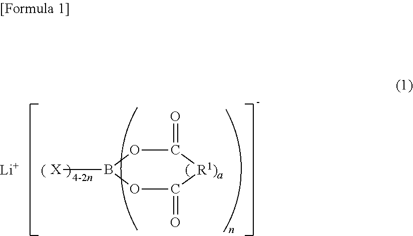

wherein X each independently represents a halogen atom selected from the group consisting of a fluorine atom, a chlorine atom, and a bromine atom; R¹ each independently represents a hydrocarbon group which has 1 to 10 carbon atoms and which may have a substituent; a represents an integer of 0 or 1; and n represents an integer of 0 to 2, and/or formula (2):

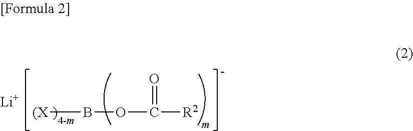

wherein X each independently represents a halogen atom selected from the group consisting of a fluorine atom, a chlorine atom, and a bromine atom; R² each independently represents a hydrogen atom, a fluorine atom, or a hydrocarbon group which has 1 to 10 carbon atoms and which may have a substituent; and m represents an integer of 0 to 4; and

a compound (C) in which at least one of hydrogen atoms in an acid selected from the group consisting of proton acids having a phosphorus atom and/or a boron atom, sulfonic acids, silicic acids and carboxylic acids is replaced with a substituent represented by formula (3):

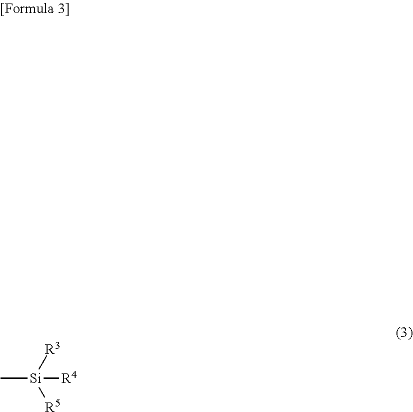

wherein R³, R⁴, and R⁵ each independently represent an organic group which has 1 to 10 carbon atoms and which may have a substituent.
[2]

The electrolytic solution for the non-aqueous energy storage device according to [1] above, wherein the compound (C) comprises a compound represented by formula (4):

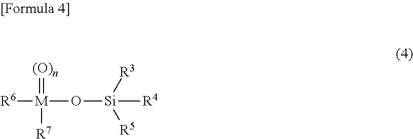

wherein M represents a phosphorus atom or a boron atom; n is 0 or 1 when M is a phosphorus atom; n is 0 when M is a boron atom; R³, R⁴, and R⁵ each independently represent an organic group which has 1 to 10 carbon atoms and which may have a substituent; and R⁶ and R⁷ each independently represent a group selected from the group consisting of an OH group, an OLi group, an alkyl group which has 1 to 10 carbon atoms and which may have a substituent, an alkoxy group which has 1 to 10 carbon atoms and which may have a substituent, a siloxy group having 3 to 10 carbon atoms, an aryl group having 6 to 15 carbon atoms, and an aryloxy group having 6 to 15 carbon atoms;
and/or a compound represented by formula (5):

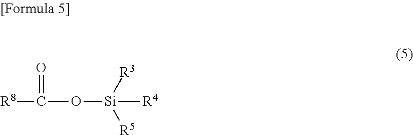

wherein R³, R⁴, and R⁵ each independently represent an organic group which has 1 to 10 carbon atoms and which may have a substituent; and R⁸ represents an organic group which has 1 to 20 carbon atoms and which may have a substituent.
[3]

The electrolytic solution for the non-aqueous energy storage device according to [1] or [2] above, wherein a content of the lithium salt (A) is 1% by mass or more and 40% by mass or less based on 100% by mass of the electrolytic solution for the non-aqueous energy storage device,

a content of the lithium salt (B) is 0.01% by mass or more and 10% by mass or less based on 100% by mass of the electrolytic solution for the non-aqueous energy storage device, and

a content of the compound (C) is 0.01% by mass or more and 10% by mass or less based on 100% by mass of the electrolytic solution for the non-aqueous energy storage device.

[4]

The electrolytic solution for the non-aqueous energy storage device according to any one of [1] to [3] above, wherein the lithium salt (B) is one or more selected from the group consisting of LiBF₄, LiB(C₂O₄)₂, and LiBF₂(C₂O₄).

[5]

The electrolytic solution for the non-aqueous energy storage device according to any one of [1] to [4] above, wherein the lithium salt (A) comprises LiPF₆.

[6]

The electrolytic solution for the non-aqueous energy storage device according to any one of [1] to [5] above, further comprising one or more lithium salts selected from the group consisting of lithium difluorophosphate and lithium monofluorophosphate.

[7]

The electrolytic solution for the non-aqueous energy storage device according to any one of [1] to [6] above, wherein the non-aqueous solvent comprises a cyclic carbonate and a linear carbonate.

The electrolytic solution for the non-aqueous energy storage device according to [7] above, wherein the cyclic carbonate comprises one or more selected from the group consisting of ethylene carbonate and propylene carbonate, and

the linear carbonate comprises one or more selected from the group consisting of dimethyl carbonate, diethyl carbonate, and ethylmethyl carbonate.

[9]

A lithium ion secondary battery, comprising:

a positive electrode having a positive electrode active material,

a negative electrode having a negative electrode active material, and

the electrolytic solution for the non-aqueous energy storage device according to any one of [1] to [8] above.

[10]

The lithium ion secondary battery according to [9] above, wherein the positive electrode active material has a discharge capacity of 10 mAh/g or more at a potential of 4.4 V (vsLi/Li⁺) or more.

[11]

The lithium ion secondary battery according to [9] or [10] above, wherein the positive electrode active material is one or more selected from the group consisting of:

oxides represented by formula (6):

LiMn₂₋ₓMaₓO₄ (6)

wherein Ma represents one or more selected from the group consisting of transition metals; and x is 0.2≦x≦0.7;

oxides represented by formula (7):

LiMn₁₋ᵤMeᵤO₂ (7)

wherein Me represents one or more selected from the group consisting of transition metals except Mn; and u is 0.11≦u≦0.9;

complex oxides represented by formula (8):

zLi₂McO₃-(1-z)LiMdO₂ (8)

wherein Mc and Md each independently represent one or more selected from the group consisting of transition metals; and z is 0.1≦z≦0.9;

compounds represented by formula (9):

LiMb_{1-y}Fe_{y}PO₄ (9)

wherein Mb represents one or more selected from the group consisting of Mn and Co; and y is 0≦y≦0.9; and

compounds represented by formula (10):

Li₂MfPO₄F (10)

wherein Mf represents one or more selected from the group consisting of transition metals.
[12]

The lithium ion secondary battery according to any one of [9] to [1,1] above, wherein a potential of the positive electrode versus lithium in a fully charged battery is 4.4 V (vsLi/Li⁺) or more.

### Advantageous Effects of the Invention

The present invention can provide a lithium ion secondary battery that operates at a high voltage, has a high cycle life, and generates less gas, and an electrolytic solution for the non-aqueous energy storage device used for the lithium ion secondary battery.

### BRIEF DESCRIPTION OF THE DRAWING

FIG. 1 is a sectional view schematically showing an example of a lithium ion secondary battery according to the present embodiment.

### DETAILED DESCRIPTION OF THE PREFERRED EMBODIMENT

Hereinafter, an embodiment of the present invention (hereinafter, referred simply to as “the present embodiment”) will be specifically described referring to the drawing when necessary. The present embodiment below is one example for describing the present invention, and will not limit the present invention to the following content. The present invention can be properly modified within the scope of the gist and implemented. Vertical and horizontal positional relationships such as left, right, up, down are based on the positional relationships shown in the drawing, unless otherwise specified.

Further, dimensional ratios in the drawing will not be limited to the ratios shown in the drawing.

### [Electrolytic Solution for Non-Aqueous Energy Storage Device]

The electrolytic solution for a non-aqueous energy storage device (hereinafter, referred simply to as an “electrolytic solution”) according to the present embodiment comprises:

a non-aqueous solvent;

a lithium salt (A) having no boron atom;

a lithium salt (B) containing a boron atom represented by formula (1):

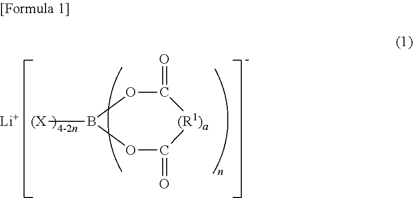

wherein X each independently represents a halogen atom selected from the group consisting of a fluorine atom, a chlorine atom, and a bromine atom; R¹ each independently represents a hydrocarbon group which has 1 to 10 carbon atoms and which may have a substituent; a represents an integer of 0 or 1; and n represents an integer of 0 to 2,

and/or formula (2):

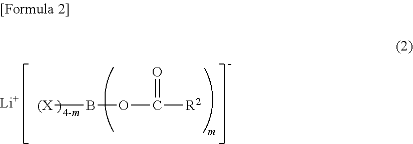

wherein X each independently represents a halogen atom selected from the group consisting of a fluorine atom, a chlorine atom, and a bromine atom; R² each independently represents a hydrogen atom, a fluorine atom, or a hydrocarbon group which has 1 to 10 carbon atoms and which may have a substituent; and m represents an integer of 0 to 4; and

a compound (C) in which at least one of hydrogen atoms in an acid selected from the group consisting of proton acids having a phosphorus atom and/or a boron atom, sulfonic acids, and carboxylic acids is replaced with a substituent represented by formula (3):

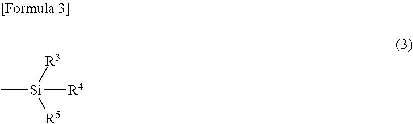

wherein R³, R⁴, and R⁵ each independently represent an organic group which has 1 to 10 carbon atoms and which may have a substituent.

### [Non-Aqueous Solvent]

The electrolytic solution according to the present embodiment comprises a non-aqueous solvent. The non-aqueous solvent is not particularly limited, and examples thereof include aprotic polar solvents. The aprotic polar solvents are not particularly limited, and examples thereof include cyclic carbonates such as ethylene carbonate, propylene carbonate, 1,2-butylene carbonate, 2,3-butylene carbonate, 1,2-pentylene carbonate, 2,3-pentylene carbonate, trifluoromethylethylene carbonate, fluoroethylene carbonate, and 4,5-difluoroethylene carbonate; lactones such as γ-butyrolactone and γ-valerolactone; cyclic sulfones such as sulfolane; cyclic ethers such as tetrahydrofuran and dioxane; linear carbonates such as ethylmethyl carbonate, dimethyl carbonate, diethyl carbonate, methylpropyl carbonate, methylisopropyl carbonate, dipropyl carbonate, methylbutyl carbonate, dibutyl carbonate, ethylpropyl carbonate, and methyltrifluoroethyl carbonate; nitriles such as acetonitrile; linear ethers such as dimethyl ether; linear carboxylic acid esters such as methyl propionate; and linear diethers such as dimethoxyethane.

### (Carbonates)

The non-aqueous solvent is not particularly limited. For example, use of a carbonate solvent such as cyclic carbonates and linear carbonates is more preferable. Still more preferably, a cyclic carbonate is used in combination with a linear carbonate as the carbonate solvent. The electrolytic solution containing such a carbonate tends to have high ion conducting properties.

### (Cyclic Carbonates)

Cyclic carbonates are not particularly limited, and examples thereof include ethylene carbonate, propylene carbonate, and fluoroethylene carbonate. Among these, one or more selected from the group consisting of ethylene carbonate and propylene carbonate are preferable, for example. The electrolytic solution containing such a cyclic carbonate tends to have high ion conducting properties.

### (Linear Carbonates)

Linear carbonates are not particularly limited, and one or more selected from the group consisting of dimethyl carbonate, diethyl carbonate, and ethylmethyl carbonate are preferable, for example. The electrolytic solution containing such a linear carbonate tends to have high ion conducting properties.

In the case where the carbonate solvent contains a cyclic carbonate in combination with a linear carbonate, the mixing ratio of the cyclic carbonate to the linear carbonate is a volume ratio of preferably 1:10 to 5:1, more preferably 1:5 to 3:1, and still more preferably 1:5 to 1:1. At a mixing ratio within the range above, the lithium ion secondary battery tends to have high ion conducting properties.

In the case where the carbonate solvent is used, another non-aqueous solvent such as acetonitrile and sulfolane can be further added when necessary. Use of such a non-aqueous solvent tends to be further improved the battery physical properties of the lithium ion secondary battery.

These non-aqueous solvents can be used alone or in combination.

### [Lithium Salt (A)]

The electrolytic solution according to the present embodiment comprises a lithium salt (A) having no boron atom. The lithium salt (A) may have the function of acting on a positive electrode or a negative electrode or both thereof to suppress decomposition by oxidation of the electrolytic solution. It is thought that the lithium salt (A) mainly has a function as an electrolyte responsible for the ion conducting properties of the electrolytic solution.

The content of the lithium salt (A) in the electrolytic solution is preferably 1% by mass or more and 40% by mass or less, more preferably 5% by mass or more and 35% by mass or less, and still more preferably 7% by mass or more and 30% by mass or less, based on 100% by mass of the electrolytic solution. When the content of the lithium salt (A) in the electrolytic solution is 1% by mass or more, the lithium ion secondary battery tends to have high ion conducting properties. When the content of the lithium salt (A) in the electrolytic solution is 40% by mass or less, the lithium salt (A) tends to have further improved solubility at a low temperature. The content of the lithium salt (A) in the electrolytic solution can be found by NMR measurement such as ¹⁹F-NMR and ³¹P-NMR. The content of the lithium salt (A) in the electrolytic solution in the lithium ion secondary battery can also be found by NMR measurement such as ¹⁹F-NMR and ³¹P-NMR in the same manner as above.

The structure of the lithium salt (A) is not particularly limited and can have any structure as long as the molecule structure has no boron atom. For example, LiPF₆, LiClO₄, LiAsF₆, Li₂SiF₆, LiOSO₂CₖF₂ₖ₊₁ [k is an integer of 1 to 8], LiN(SO₂CₖF₂ₖ₊₁)₂ [k is an integer of 1 to 8], LiPFₙ(CₖF₂ₖ₊₁)₆₋ₙ [n is an integer of 1 to 5, k is an integer of 1 to 8], LiPF₄(C₂O₂), and LiPF₂(C₂O₂)₂ are preferable; LiPF₆, LiOSO₂CₖF₂ₖ₊₁ [k is an integer of 1 to 8], LiN(SO₂CₖF₂ₖ₊₁)₂ [k is an integer of 1 to 8], LiPFₙ(CₖF₂ₖ₊₁)₆₋ₙ [n is an integer of 1 to 5, k is an integer of 1 to 8], LiPF₄(C₂O₂), and LiPF₂(C₂O₂)₂ are more preferable; LiPF₆ is still more preferable. By use of such a lithium salt (A), the lithium ion secondary battery tends to have high ion conducting properties.

These lithium salts (A) can be used alone or in combination.

### [Lithium Salt (B)]

The electrolytic solution according to the present embodiment comprises a lithium salt (B) containing a boron atom represented by formula (1):

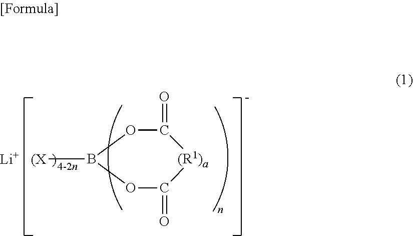

wherein X each independently represents a halogen atom selected from the group consisting of a fluorine atom, a chlorine atom, and a bromine atom; R¹ each independently represents a hydrocarbon group which has 1 to 10 carbon atoms and which may have a substituent; a represents an integer of 0 or 1; and n represents an integer of 0 to 2, and/or formula (2):

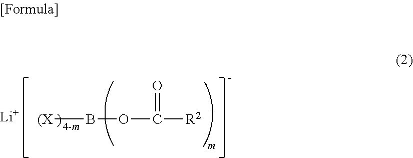

wherein X each independently represents a halogen atom selected from the group consisting of a fluorine atom, a chlorine atom, and a bromine atom; R² each independently represents a hydrogen atom, a fluorine atom, or a hydrocarbon group which has 1 to 10 carbon atoms and which may have a substituent; and m represents an integer of 0 to 4.

### (Lithium Salt (B) Having Boron Atom Represented by Formula (1))

In the lithium salt (B) having a boron atom represented by formula (1), X represents a halogen atom selected from the group consisting of a fluorine atom, a chlorine atom, and a bromine atom. Among these, X preferably represents a fluorine atom. When X is a fluorine atom, the chemical durability of the lithium salt in the lithium ion secondary battery tends to be further improved.

R¹ each independently represents a hydrocarbon group which has 1 to 10 carbon atoms and which may have a substituent. The hydrocarbon group is not particularly limited, and examples thereof include aromatic hydrocarbon groups such as aliphatic hydrocarbon groups and a phenyl group; and fluorine-substituted hydrocarbon groups in which a hydrogen atom is substituted by a fluorine atom, such as a difluoromethylene group. The hydrocarbon group may have a functional group when necessary. Such a functional group is not particularly limited, and examples thereof include halogen atoms such as a fluorine atom, a chlorine atom, and a bromine atom, a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), and an urethane group (—NHCO₂—).

The hydrocarbon group represented by R¹ has 1 to 10 carbon atoms, preferably 1 to 8 carbon atoms, and more preferably 1 to 6 carbon atoms. When the hydrocarbon group represented by R¹ has carbon atoms within the range above, compatibility with the non-aqueous solvent tends to be enhanced.

Preferable examples of R¹ are not particularly limited, and examples thereof include aliphatic hydrocarbon groups such as a methylene group, an ethylene group, a 1-methylethylene group, a propylene group, a butylene group, a 1,2-dimethylethylene group, a 1,2-di(trifluoromethyl)ethylene group, a fluoroethylene group; and aromatic hydrocarbon groups such as a phenyl group, a nitrile-substituted phenyl group, and a fluorinated phenyl group. Among these, a methylene group, an ethylene group, a 1-methylethylene group, a propylene group, a 1,2-dimethyl ethylene group, a 1,2-di(trifluoromethyl)ethylene group, and a fluoroethylene group are more preferable. When R¹ is such a hydrocarbon group, the lithium ion secondary battery tends to have high ion conducting properties.

In formula (1), a represents an integer of 0 or 1, and a is preferably 0. When a is 0, stability tends to be enhanced. When a is 0, the right structure in formula (1) is an oxalic acid structure. In formula (1), n represents an integer of 0 to 2.

The lithium salt (B) having a boron atom represented by formula (1) is not particularly limited. More preferably, the lithium salt (B) having a boron atom represented by formula (1) has one of the structures represented by formula (11) to formula (17), for example. Among these, LiB(C₂O₄)₂ represented by formula (11) (hereinafter, also referred to as “LiBOB”), LiBF₂(C₂O₄) represented by formula (12), and LiBF₄ represented by formula (13) are preferable, LiBOB represented by formula (11) and LiBF₂(C₂O₄) represented by formula (12) are more preferable. By use of such a lithium salt (B), the chemical durability in the lithium ion secondary battery tends to be enhanced.

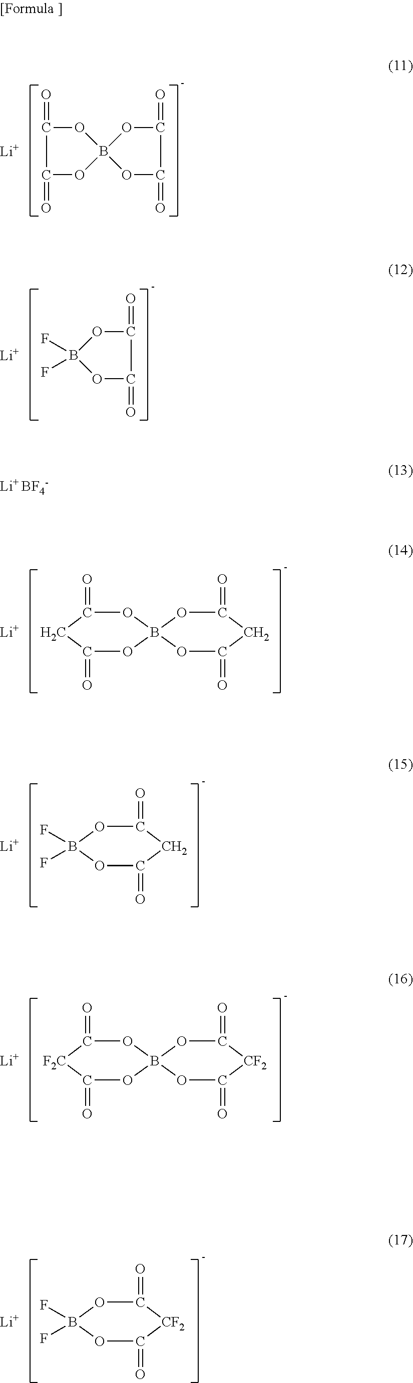

### (Lithium Salt (B) Having Boron Atom Represented by Formula (2))

In the lithium salt (B) having a boron atom represented by formula (2), X each independently represents a halogen atom selected from the group consisting of a fluorine atom, a chlorine atom, and a bromine atom. Among these, X preferably represents a fluorine atom. When X is a fluorine atom, the chemical durability of the lithium salt in the lithium ion secondary battery tends to be further improved.

R² each independently represents a hydrogen atom, a fluorine atom, or a hydrocarbon group which has 1 to 10 carbon atoms and which may have a substituent. The hydrocarbon group is not particularly limited, and examples thereof include aromatic hydrocarbon groups such as aliphatic hydrocarbon groups and a phenyl group, and fluorine-substituted hydrocarbon groups in which all the hydrogen atoms in the hydrocarbon group are substituted by a fluorine atom, such as a trifluoromethyl group. The hydrocarbon group may have a functional group when necessary. Such a functional group is not particularly limited, and examples thereof include halogen atoms such as a fluorine atom, a chlorine atom, and a bromine atom, a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), and an urethane group (—NHCO₂—).

Preferable examples of R² are not particularly limited, and examples thereof include aliphatic hydrocarbon groups such as a methyl group, an ethyl group, a vinyl group, a 1-methylvinyl group, a propyl group, a butyl group, and a trifluoromethyl group; and aromatic hydrocarbon groups such as a benzyl group, a phenyl group, a nitrile-substituted phenyl group, and a fluorinated phenyl group. Among these, a methyl group, an ethyl group, a vinyl group, a 1-methylvinyl group, and a trifluoromethyl group are more preferable. When R² is such a hydrocarbon group, the lithium ion secondary battery tends to have higher ion conducting properties.

When R² is a hydrocarbon group, R₂ has 1 to 10 carbon atoms, preferably 1 to 8 carbon atoms, and more preferably 1 to 6 carbon atoms from the viewpoint of the compatibility with the non-aqueous solvent. In formula (2), m represents an integer of 0 to 4.

The lithium salt (B) having a boron atom represented by formula (2) is not particularly limited. For example, the lithium salt (B) having a boron atom represented by formula (2) is more preferably LiBF₄, LiBF₃(OCOCH₃), LiBF₃(OCOCF₃), LiBF₂(OCOCH₃)₂, LiBF₂(OCOCF₃)₂, LiBF(OCOCH₃)₃, LiBF(OCOCF₃)₃, LiB(OCOCH₃)₄, and LiB(OCOCF₃)₄. Among these, LiBF₄ is more preferable. By use of such a lithium salt (B), the chemical durability in the lithium ion secondary battery tends to be enhanced.

The content of the lithium salt(s) (B) having a boron atom represented by formula (1) and/or formula (2) is preferably 0.01% by mass or more and 10% by mass or less, more preferably 0.02% by mass or more and 5% by mass or less, still more preferably 0.03% by mass or more and 5% by mass or less, further still more preferably 0.05% by mass or more and 3% by mass or less, and particularly preferably 0.1% by mass or more and 2% by mass or less, based on 100% by mass of the electrolytic solution. At a content of the lithium salt (B) of 0.01% by mass or more, the cycle life of the lithium ion secondary battery tends to be further improved. At a content of the lithium salt (B) of 10% by mass or less, the battery output of the lithium ion secondary battery tends to be further improved. As described above, because the lithium salt (B) can mainly function as an additive for improving the cycle life, even a small amount of the lithium salt (B) in the electrolytic solution of 0.01% by mass or more and 10% by mass or less tends to exhibit a sufficient effect. The content of these lithium salts (B) in the electrolytic solution can be found by NMR measurement such as ¹¹B-NMR and ¹⁹F-NMR. The content of the lithium salts (B) in the electrolytic solution in the lithium ion secondary battery can also be found by NMR measurement such as ¹¹B-NMR and ¹⁹F-NMR in the same manner as above.

These lithium salts (B) can used alone or in combination.

The electrolytic solution according to the present embodiment containing the lithium salt (B) in addition to the compound (C) and the lithium salt (A) can significantly improve the cycle life of the lithium ion secondary battery, and significantly suppress the gas to be generated. Although the reason is not clear, it is presumed that the lithium salt (B) and the compound (C) act to the positive electrode or negative electrode or both thereof to suppress decomposition by oxidation of the electrolytic solution inside of the lithium ion secondary battery. The lithium salt (B) has a function as an electrolyte responsible for ion conducting properties, but mainly functions as an additive for improving the cycle life and significantly suppressing the gas to be generated in cooperation with the compound (C). The function as the additive can be sufficiently exhibited even by a small amount of the lithium salt (B) in the electrolytic solution of 0.01% by mass or more and 10% by mass or less.

### [Compound (C)]

The electrolytic solution according to the present embodiment comprises the compound (C) in which at least one of hydrogen atoms in an acid selected from the group consisting of proton acids having a phosphorus atom and/or a boron atom, sulfonic acids, and carboxylic acids is replaced with a structure represented by formula (3):

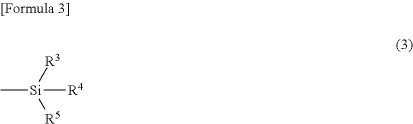

wherein R³, R⁴, and R⁵ each independently represent an organic group which has 1 to 10 carbon atoms and which may have a substituent.

The proton acid having a phosphorus atom is not particularly limited as long as the proton acid is a compound having a phosphorus atom and a hydrogen atom that can dissociate as a proton in the molecule. The proton acid having a phosphorus atom may contain a halogen atom such as a fluorine atom and a chlorine atom, an organic group such as an alkoxy group and an alkyl group, and different atoms such as Si, B, O, and N in the molecule. The proton acid having a phosphorus atom may contain a plurality of phosphorus atoms in the molecule, for example, polyphosphoric acid. Such a proton acid having a phosphorus atom is not particularly limited. For example, phosphoric acid, phosphorous acid, pyrophosphoric acid, polyphosphoric acid, and phosphonic acid are preferable. Among these, phosphoric acid, phosphorous acid, and phosphonic acid are more preferable. By use of such a compound (C), stability tends to be enhanced. These proton acids may have a substituent.

The proton acid having a boron atom is not particularly limited as long as the proton acid is a compound having a boron atom and a hydrogen atom that can dissociate as a proton in the molecule. The proton acid having a boron atom may contain a halogen atom such as a fluorine atom and a chlorine atom, an organic group such as an alkoxy group and an alkyl group, and different atoms such as Si, P, O, and N in the molecule. The proton acid having a boron atom may contain a plurality of boron atoms in the molecule. Such a proton acid having a boron atom is not particularly limited. For example, boric acid, boronic acid, and borinic acid are preferable. These proton acids may have a substituent.

Sulfonic acid is not particularly limited as long as sulfonic acid is a compound having a —SO₃H group (sulfonic acid group) in the molecule, and may have a plurality of sulfonic acid groups in the molecule. In the present embodiment, sulfonic acid includes sulfuric acid (HOSO₃H). Sulfonic acid is not particularly limited, and preferable examples thereof can include methylsulfonic acid, ethylsulfonic acid, propylsulfonic acid, 1,2-ethanedisulfonic acid, trifluoromethylsulfonic acid, phenylsulfonic acid, benzylsulfonic acid, and sulfuric acid.

Carboxylic acid is not particularly limited as long as carboxylic acid is a compound having a CO₂H group (carboxylic acid group) in the molecule, and may have a plurality of carboxylic acid groups in the molecule. Carboxylic acid is not particularly limited, and examples thereof include acetic acid, trifluoroacetic acid, propionic acid, butyric acid, valeric acid, acrylic acid, methacrylic acid, oleic acid, linoleic acid, linolenic acid, benzoic acid, phthalic acid, isophthalic acid, terephthalic acid, salicylic acid, malonic acid, fumaric acid, succinic acid, glutaric acid, adipic acid, and itaconic acid. Among these, dicarboxylic acids such as benzoic acid, phthalic acid, isophthalic acid, terephthalic acid, salicylic acid, malonic acid, fumaric acid, succinic acid, glutaric acid, adipic acid, and itaconic acid are preferable, and adipic acid, itaconic acid, succinic acid, isophthalic acid, and terephthalic acid are more preferable.

The compound (C) is a compound (C) in which at least one of hydrogen atoms in an acid selected from the group consisting of proton acids, sulfonic acids, and carboxylic acids is replaced with a structure represented by formula (3). Here, in the structure represented by formula (3), R³, R⁴, and R⁵ each independently represent a hydrocarbon group which has 1 to 10 carbon atoms and which may have a substituent.

The hydrocarbon group is not particularly limited, and examples thereof include aromatic hydrocarbon groups such as aliphatic hydrocarbon groups and a phenyl group, and fluorine-substituted hydrocarbon groups in which all the hydrogen atoms in the hydrocarbon group are substituted by a fluorine atom, such as a trifluoromethyl group. The hydrocarbon group may have a functional group when necessary. Such a functional group is not particularly limited, and examples thereof include halogen atoms such as a fluorine atom, a chlorine atom, and a bromine atom, a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), and an urethane group (—NHCO₂—).

Preferable examples of R³, R⁴, and R⁵ are not particularly limited, and examples thereof include aliphatic hydrocarbon groups such as a methyl group, an ethyl group, a vinyl group, a 1-methylvinyl group, a propyl group, a butyl group, and a fluoromethyl group; and aromatic hydrocarbon groups such as a benzyl group, a phenyl group, a nitrile-substituted phenyl group, and a fluorinated phenyl group. Among these, a methyl group, an ethyl group, a vinyl group, a 1-methylvinyl group, and a fluoromethyl group are more preferable from the viewpoint of chemical stability. Two R may be bonded to each other to form a ring. To form a ring, examples of the method include substitution by a substituted or non-substituted, saturated or unsaturated alkylene group.

R³, R⁴, and R⁵ have 1 to 10 carbon atoms, and more preferably 1 to 8 carbon atoms, and still more preferably 1 to 6 carbon atoms. When R³, R⁴, and R⁵ have carbon atoms within the range above, the compatibility with the non-aqueous solvent tends to be enhanced.

The structure represented by formula (3) is not particularly limited. For example, —Si(CH₃)₃, —Si(C₂H₅)₃, —Si(CHCH₂)₃, —Si(CH₂CHCH₂)₃, and —Si(CF₃)₃ are preferable, and —Si(CH₃)₃ is more preferable. When the compound (C) includes such a structure, the chemical durability in the lithium ion secondary battery tends to be further improved.

In the case where an acid selected from the group consisting of proton acids, sulfonic acids, and carboxylic acids has a plurality of hydrogen atoms, at least one hydrogen atom may be substituted by the structure represented by formula (3). The remaining non-substituted hydrogen atoms may exist as they are, or may be substituted by a functional group having a structure other than the structure represented by formula (3). Such a functional group is not particularly limited, and preferable examples thereof can include halogen-substituted, unsubstituted saturated or unsaturated hydrocarbon groups having 1 to 20 carbon atoms. The halogen-substituted, unsubstituted saturated or unsaturated hydrocarbon groups are not particularly limited, and examples thereof include an alkyl group, an alkenyl group, an alkynyl group, an allyl group, and a vinyl group. The substituents for two hydrogen atoms may be bonded to each other to form a ring. To form a ring, examples of the method include substitution by a substituted or non-substituted, saturated or unsaturated alkylene group.

The compound (C) is not particularly limited. For example, compounds represented by formula (4) and/or compounds represented by formula (5) are preferable.

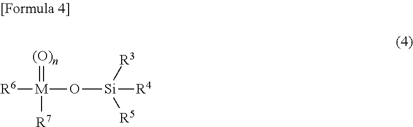

wherein M represents a phosphorus atom (hereinafter, also referred to as a “P atom”) or a boron atom (hereinafter, also referred to as a “B atom”); n is 0 or 1 when M is a P atom; n is 0 when M is a B atom; R³, R⁴, and R⁵ each independently represent an organic group which has 1 to 10 carbon atoms and which may have a substituent; and R⁶ and R⁷ each independently represent a group selected from the group consisting of an OH group, an OLi group, an alkyl group which has 1 to 10 carbon atoms and which may have a substituent, an alkoxy group which has 1 to 10 carbon atoms and which may have a substituent, a siloxy group having 3 to 10 carbon atoms, an aryl group having 6 to 15 carbon atoms, and an aryloxy group having 6 to 15 carbon atoms:

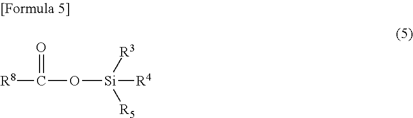

wherein R³, R⁴, and R⁵ each independently represent an organic group which has 1 to 10 carbon atoms and which may have a substituent; and R⁸ represents an organic group which has 1 to 20 carbon atoms and which may have a substituent.

In the compound (C) represented by formula (4), M represents a P atom or a B atom, n represents an integer of 0 or 1 when M is a P atom, and n represent an integer of 0 when M is a B atom. Namely, in formula (4), when M is a B atom and n is 0, the compound (C) has a boric acid structure. When M is a P atom and n is 0, the compound (C) has a phosphorous acid structure. When M is a P atom and n is 1, the compound (C) has a phosphoric acid structure. From the viewpoint of the stability of the electrolytic solution containing the compound (C), the structure represented by formula (18) in which M is a P atom:

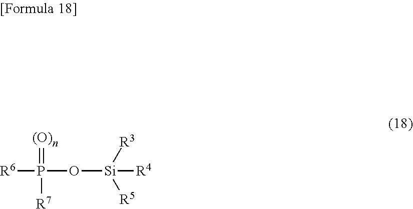

wherein R³, R⁴, and R⁵ each independently represent an organic group which has 1 to 10 carbon atoms and which may have a substituent; and R⁶ and R⁷ each independently represent a group selected from the group consisting of an OH group, an OLi group, an alkyl group which has 1 to 10 carbon atoms and which may have a substituent, an alkoxy group which has 1 to 10 carbon atoms and which may have a substituent, a siloxy group having 3 to 10 carbon atoms, an aryl group having 6 to 15 carbon atoms, and an aryloxy group having 6 to 15 carbon atoms, is more preferable.

In the compounds (C) represented by formulas (4) and (18), R⁶ and R⁷ each independently represent a group selected from the group consisting of an OH group, an OLi group, an alkyl group which has 1 to 10 carbon atoms and which may have a substituent, an alkoxy group which has 1 to 10 carbon atoms and which may have a substituent, a siloxy group having 3 to 10 carbon atoms, an aryl group having 6 to 15 carbon atoms, and an aryloxy group having 6 to 15 carbon atoms.

The alkyl group which has 1 to 10 carbon atoms and which may have a substituent has a structure in which a carbon atom is directly bonded to the M atom. The alkyl group is not particularly limited, examples thereof include aliphatic groups, and fluorine-substituted hydrocarbon groups in which at least part of hydrogen atoms are substituted by a fluorine atom, such as a trifluoromethyl group. The alkyl group may be substituted by various functional groups when necessary. Such a functional group is not particularly limited, and examples thereof include halogen atoms such as a fluorine atom, a chlorine atom, and a bromine atom; and aromatic groups such as a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), an urethane group (—NHCO₂—), a phenyl group, and a benzyl group.

Preferable examples of the alkyl group represented by R⁶ and R⁷ are not particularly limited, and examples thereof include aliphatic alkyl groups such as a methyl group, an ethyl group, a vinyl group, an allyl group, a propyl group, a butyl group, a pentyl group, a hexyl group, and a fluorohexyl group. Among these, a methyl group, an ethyl group, an allyl group, a propyl group, a butyl group, a pentyl group, a hexyl group, and a fluorohexyl group are more preferable from the viewpoint of chemical stability.

The alkyl group represented by R⁶ and R⁷ has 1 or more and 10 or less carbon atoms, preferably 2 or more and 10 or less carbon atoms, and more preferably 3 or more and 8 or less carbon atoms. When the alkyl group has 1 or more carbon atoms, battery performance tends to be further improved. When the alkyl group has 10 or less carbon atoms, affinity with the electrolytic solution tends to be further improved.

The alkoxy group which has 1 to 10 carbon atoms and which may have a substituent has a structure in which a carbon atom is bonded to the M atom via an oxygen atom. The alkoxy group is not particularly limited, and examples thereof include an alkoxy group having an aliphatic group, and fluorine-substituted alkoxy groups in which a hydrogen atom in the alkoxy group is substituted by fluorine, such as a trifluoroethyloxy group and a hexafluoroisopropoxy group. The alkoxy group may be substituted by various functional groups when necessary. Such a functional group is not particularly limited, and examples thereof include halogen atoms such as a fluorine atom, a chlorine atom, and a bromine atom; and aromatic groups such as a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), an urethane group (—NHCO₂—), a phenyl group, and a benzyl group.

Preferable examples of the alkoxy group represented by R⁶ and R⁷ are not particularly limited, and examples thereof include aliphatic alkoxy groups such as a methoxy group, an ethoxy group, a vinyloxy group, an allyloxy group, a propoxy group, a butoxy group, a cyanohydroxy group, a fluoroethoxy group, and a fluoropropoxy group. Among these, a methoxy group, an ethoxy group, a vinyloxy group, an allyloxy group, a propoxy group, a butoxy group, a cyanohydroxy group, a fluoroethoxy group, and a fluoropropoxy group are more preferable from the viewpoint of chemical stability.

The alkoxy group represented by R⁶ and R⁷ has 1 to 10 carbon atoms, preferably 1 or more and 8 or less carbon atoms, and more preferably 2 or more and 8 or less carbon atoms. When the alkoxy group represented by R⁶ and R⁷ has 1 or more carbon atoms, battery performance tends to be further improved. When the alkoxy group represented by R⁶ and R⁷ has 10 or less carbon atoms, affinity with the electrolytic solution tends to be further improved.

The siloxy group having 3 to 10 carbon atoms has a structure in which a silicon atom is bonded to the M atom via an oxygen atom. The siloxy group may contain a siloxane structure such as Si—O—Si—. The siloxy group is not particularly limited, and preferable examples thereof include a trimethylsiloxy group, a triethylsiloxy group, a dimethylethylsiloxy group, and a diethylmethylsiloxy group from the viewpoint of chemical stability. The siloxy group is more preferably a trimethylsiloxy group.

The siloxy group has 3 or more and 10 or less carbon atoms, preferably 3 or more and 8 or less carbon atoms, and more preferably 3 or more and 6 or less carbon atoms. When the siloxy group has 3 or more carbon atoms, battery performance tends to be further improved. When the siloxy group has 10 or less carbon atoms, chemical stability tends to be further improved.

The number of silicon atoms in the siloxy group is not particularly limited. The number is preferably 1 or more and 4 or less, preferably 1 or more and 3 or less, still more preferably 1 or more and 2 or less, and particularly preferably 1. When the number of silicon atoms in the siloxy group is within the range above, chemical stability and battery performance tend to be further improved.

The aryl group has a structure in which a carbon atom in an aromatic ring is directly bonded to the M atom. The aryl group may be substituted by various functional groups when necessary. Such a functional group is not particularly limited, and examples thereof include halogen atoms such as a fluorine atom, a chlorine atom, and a bromine atom, a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), an urethane group (—NHCO₂—), an alkyl group, and an alkoxy group.

Preferable examples of the aryl group are not particularly limited, and examples thereof include aromatic alkyl groups such as a benzyl group, a phenyl group, a nitrile-substituted phenyl group, and a fluorinated phenyl group.

The aryl group has 6 or more and 15 or less carbon atoms, and preferably 6 or more and 12 or less carbon atoms. When the aryl group has 6 or more carbon atoms, the chemical stability of the compound tends to be further improved. When the aryl group has 15 or less carbon atoms, battery performance tends to be further improved.

The aryloxy group has a structure in which an aryl group is bonded to the M atom via oxygen. The aryloxy group may be substituted by various functional groups when necessary. Such a functional group is not particularly limited, and examples thereof include halogen atoms such as a fluorine atom, a chlorine atom, and a bromine atom, a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), an urethane group (—NHCO₂—), an alkyl group, and an alkoxy group.

Preferable examples of the aryloxy group are not particularly limited, and examples thereof include aromatic alkoxy groups such as a phenoxy group, a benzylalkoxy group, a nitrile-substituted phenoxy group, and a fluorinated phenoxy group.

The aryloxy group has 6 or more and 15 or less carbon atoms, and preferably 6 or more and 12 or less carbon atoms. When the aryloxy group has 6 or more carbon atoms, the chemical stability of the compound tends to be further improved. When the aryloxy group has 15 or less carbon atoms, battery performance tends to be further improved.

R⁶ and R⁷ are not particularly limited. For example, an alkyl group which has 1 to 10 carbon atoms and which may have a substituent, an alkoxy group which has 1 to 10 carbon atoms and which may have a substituent, and a siloxy group having 3 to 10 carbon atoms are preferable. At least one of R⁶ and R⁷ is more preferably a functional group selected from the group consisting of an alkoxy group which has 1 to 10 carbon atoms and which may have a substituent and a siloxy group having 3 to 10 carbon atoms. When R⁶ and R⁷ are such a group, the solubility of the compound in the electrolytic solution tends to be further improved.

In the compounds (C) represented by formulas (4) and (13), R³, R⁴, and R⁵ each independently represent a hydrocarbon group having 1 to 10 carbon atoms. Preferable structures for R³, R⁴, and R⁵ are the same as those for R³, R⁴, and R⁵ in the structure represented by formula (3) described above.

In the compound (C) represented by formula (5), R⁸ represents a hydrocarbon group which has 1 to 20 carbon atoms and which may have a substituent. The hydrocarbon group represented by R⁸ is not particularly limited, and examples thereof include aromatic hydrocarbon groups such as aliphatic hydrocarbon groups and a phenyl group, and fluorine-substituted hydrocarbon groups in which all the hydrogen atoms in the hydrocarbon group are substituted by a fluorine atom, such as a trifluoromethyl group. The hydrocarbon group may be substituted by various functional groups when necessary. Such a functional group is not particularly limited, and examples thereof include halogen atoms such as a fluorine atom, a chlorine atom, and a bromine atom, a nitrile group (—CN), an ether group (—O—), a carbonate group (—OCO₂—), an ester group (—CO₂—), a carbonyl group (—CO—), a sulfide group (—S—), a sulfoxide group (—SO—), a sulfone group (—SO₂—), and an urethane group (—NHCO₂—).

Here, the hydrocarbon group represented by R⁸ has 1 or more and 20 or less carbon atoms, preferably 1 or more and 16 or less carbon atoms, and more preferably 1 or more and 14 or less carbon atoms.

The hydrocarbon group represented by R⁸ is not particularly limited, and a structure represented by formula (19):

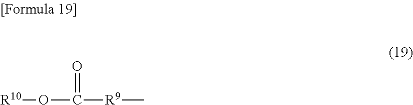

wherein R⁹ represents a hydrocarbon group which has 1 to 13 carbon atoms and which may have a substituent; R¹⁰ represents a hydrocarbon group which has 1 to 6 carbon atoms and which may have a substituent, or a trialkylsilyl group which has 3 to 6 carbon atoms and which may have a substituent, is preferable. In this case, the basic skeleton of the compound (C) is a dicarboxylic acid derivative structure.

In formula (19), from the viewpoint of the chemical stability of the compound (C), preferable examples of R⁹ include a methylene group, an ethylene group, a propylene group, a butylene group, a phenyl group, a fluoromethylene group, a fluoroethylene group, a fluoropropylene group, and a fluorobutylene group.

In formula (19), from the viewpoint of the chemical stability of the compound (C), preferable examples of R¹⁰ include a methyl group, an ethyl group, a vinyl group, an allyl group, and a trialkyl silyl group such as a trimethylsilyl group and a triethylsilyl group. More preferable examples of R¹⁰ include a trialkyl silyl group such as a trimethylsilyl group and a triethylsilyl group. Particularly, when R¹⁰ is a trialkyl silyl group, the compound (C) has a structure represented by formula (20):

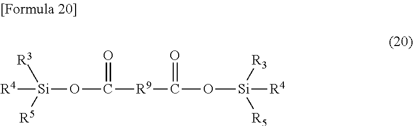

wherein R³, R⁴, and R⁵ each independently represent an organic group having 1 to 10 carbon atoms; R⁹ represents a hydrocarbon group which has 1 to 13 carbon atoms and which may have a substituent.

Preferable specific examples of the compound (C) are not particularly limited, and examples thereof include tris(trimethylsilyl)phosphate, tris(trimethylsilyl)phosphite, tris(triethylsilyl)phosphate, tetrakis(trimethylsilyl)pyrophosphate, trimethylsilyl polyphosphate, di(trimethylsilyl)butylphosphonate, di(trimethylsilyl)propylphosphonate, di(trimethylsilyl)ethylphosphonate, di(trimethylsilyl)methylphosphonate, monomethyldi(trimethylsilyl)phosphate, monoethyldi(trimethylsilyl)phosphate, mono(trifluoroethyl)di(trimethylsilyl)phosphate, mono(hexafluoroisopropyl)di(trimethylsilyl)phosphate, tris(trimethylsilyl)borate, di(trimethylsilyl)sulfate, trimethylsilyl acetate, di(trimethylsilyl)oxalate, di(trimethylsilyl)malonate, di(trimethylsilyl)succinate, di(trimethylsilyl)itaconate, di(trimethylsilyl)adipate, di(trimethylsilyl)phthalate, di(trimethylsilyl)isophthalate, and di(trimethylsilyl)terephthalate. Among these, tris(trimethylsilyl)phosphate, tris(trimethylsilyl)phosphite, tetrakis(trimethylsilyl)pyrophosphate, trimethylsilyl polyphosphate, di(trimethylsilyl)butylphosphonate, di(trimethylsilyl)propylphosphonate, di(trimethylsilyl)ethylphosphonate, di(trimethylsilyl)methylphosphonate, monomethyldi(trimethylsilyl)phosphate, monoethyldi(trimethylsilyl)phosphate, mono(trifluoroethyl)di(trimethylsilyl)phosphate, mono(hexafluoroisopropyl)di(trimethylsilyl)phosphate, di(trimethylsilyl)succinate, di(trimethylsilyl)itaconate, and di(trimethylsilyl)adipate are more preferable from the viewpoint of increase in the cycle life and suppression of the gas to be generated.

The content of the compound (C) is preferably 0.01% by mass or more and 10% by mass or less, more preferably 0.02% by mass or more and 10% by mass or less, still more preferably 0.05% by mass or more and 8% by mass or less, still more preferably 0.1% by mass or more and 5% by mass or less, and particularly preferably 0.2% by mass or more and 4% by mass or less, based on 100% by mass of the electrolytic solution. At a content of the compound (C) of 0.01% by mass or more, the cycle life of the lithium ion secondary battery tends to be further improved. At a content of the compound (C) of 10% by mass or less, the battery output tends to be further improved. The content of the compound (C) in the electrolytic solution can be found by NMR measurement. The content of the compound (C) in the electrolytic solution in the lithium ion secondary battery can also be found by NMR measurement in the same manner as above.

### [Lithium Salt (D)]

The electrolytic solution according to the present embodiment can contain a lithium salt (D) other than the compounds above. The lithium salt (D) is not particularly limited, and examples thereof include one or more lithium salts selected from the group consisting of lithium difluorophosphate and lithium monofluorophosphate. By use of the other lithium salt, the cycle performance of the lithium ion secondary battery tends to be further improved.

The content of the lithium salt (D) is preferably 0.001% by mass or more, more preferably 0.005% by mass or more, and still more preferably 0.02% by mass or more, based on 100% by mass of the electrolytic solution. At a content of the lithium salt (D) of 0.001% by mass or more, the cycle life of the lithium ion secondary battery tends to be further improved. The content of the lithium salt (D) is preferably 3% by mass or less, more preferably 2% by mass or less, and still more preferably 1% by mass or less. At a content of the lithium salt (D) of 3% by mass or less, the ion conducting properties of the lithium ion secondary battery tend to be further improved. The content of the lithium salt (D) in the electrolytic solution can be found by NMR measurement such as ³¹P-NMR and ¹⁹F-NMR. The content of the lithium salt (D) in the electrolytic solution in the lithium ion secondary battery can also be found by NMR measurement in the same manner as above.

### [Additives]

The electrolytic solution according to the present embodiment may contain additives other than the lithium salt (A), the lithium salt (B), the compound (C), and the lithium salt (D) above when necessary. Such additives are not particularly limited, and examples thereof include additives such as vinylene carbonate, fluoroethylene carbonate, ethylene sulfite, propane sultone, and succinonitrile. By use of such additives, the cycle properties of the battery tend to be further improved.

The electrolytic solution according to the present embodiment is suitably used as the electrolytic solution for the non-aqueous energy storage device. Here, the non-aqueous energy storage device is an energy storage device using no aqueous solution as an electrolytic solution in the energy storage device. Examples thereof include lithium ion secondary batteries, sodium ion secondary batteries, calcium ion secondary batteries, and lithium ions capacitors. Among these, lithium ion secondary batteries and lithium ions capacitors are preferable, and lithium ion secondary batteries are more preferable as the non-aqueous energy storage device from the viewpoint of practicality and durability.

### [Lithium Ion Secondary Battery]

The lithium ion secondary battery (hereinafter, also referred simply to as a “battery”) according to the present embodiment includes the electrolytic solution, a positive electrode having a positive electrode active material, and a negative electrode having a negative electrode active material. The battery may have the same configuration as that of the conventional lithium ion secondary battery except that the battery includes the electrolytic solution above.

### [Positive Electrode]

The positive electrode is not particularly limited as long as the positive electrode acts as a positive electrode for the lithium ion secondary battery, and known positive electrodes can be used. Preferably, the positive electrode contains one or more selected from the group consisting of materials that can intercalate and deintercalate lithium ions as the positive electrode active material.

### (Positive Electrode Active Material)

From the viewpoint of attaining higher voltage, more preferably, the battery according to the present embodiment includes a positive electrode having a positive electrode active material that has a discharge capacity of 10 mAh/g or more at a potential of 4.4 V (vsLi/Li⁺) or more. Even if the battery according to the present embodiment includes such a positive electrode, the battery is useful in enabling improvement in recycle life. Here, the positive electrode active material having a discharge capacity of 10 mAh/g or more at a potential of 4.4 V (vsLi/Li⁺) or more is a positive electrode active material that can make a charge and discharge reaction at a potential of 4.4 V (vsLi/Li⁺) or more as the positive electrode for the lithium ion secondary battery, and has a discharge capacity of 10 mAh or more based on 1 g of the active material during discharge of a constant current of 0.1 C. Accordingly, the positive electrode active material may have a discharge capacity of 10 mAh/g or more at a potential of 4.4 V (vsLi/Li⁺) or more, and may have a discharge capacity at a potential of 4.4 V (vsLi/Li⁺) or less without a problem.

The discharge capacity of the positive electrode active material used in the present embodiment is preferably 10 mAh/g or more, more preferably 15 mAh/g or more, and still more preferably 20 mAh/g or more at a potential of 4.4 V (vsLi/Li⁺) or more. At a discharge capacity of the positive electrode active material within the range above, the battery can be driven at a high voltage to attain a high energy density. The discharge capacity of the positive electrode active material can be measured by the method described in Examples.

Such a positive electrode active material is not particularly limited. For example, one or more selected from the group consisting of: oxides represented by formula (6):

LiMn₂₋ₓMaₓO₄ (6)

wherein Ma represents one or more selected from the group consisting of transition metals; and x is 0.2≦x≦0.7;

oxides represented by formula (7):

LiMn₁₋ᵤMeᵤO₂ (7)

wherein Me represents one or more selected from the group consisting of transition metals except Mn; and u is 0.11≦u≦0.9;

complex oxides represented by formula (8):

zLi₂McO₃-(1-z)LiMdO₂ (8)

wherein Mc and Md each independently represent one or more selected from the group consisting of transition metals; and z is 0.1≦z≦0.9;

compounds represented by formula (9):

LiMb_{1-y}Fe_{y}PO₄ (9)

wherein Mb represents one or more selected from the group consisting of Mn and Co; and y is 0≦y≦0.9; and

compounds represented by formula (10):

Li₂MfPO₄F (10)

wherein Mf represents one or more selected from the group consisting of transition metals,
are preferable. By use of such a positive electrode active material, the structure stability of the positive electrode active material tends to be enhanced.

The spinel type positive electrode active material that is the oxide represented by formula (6) is not particularly limited. Oxides represented by formula (6a):

LiMn₂₋ₓNiₓO₄ (6a)

wherein 0.2≦x≦0.7,
are preferable, and oxides represented by formula (6b):

LiMn₂₋ₓNiₓO₄ (6b)

wherein 0.3≦x≦0.6,
are more preferable.

The oxides represented by formula (6a) or (6b) are not particularly limited, and examples thereof include LiMn_{1.5}Ni_{0.5}O₄ and LiMn_{1.6}Ni_{0.4}O₄. By use of the spinel type oxide represented by formula (6), stability tends to be enhanced.

Here, the spinel type oxide represented by formula (6) may further contain 10 mol % or less of a transition metal or transition metal oxide based on the amount by mole of the Mn atom except the structure from the viewpoint of stability and electron conducting properties of the positive electrode active material. These compounds represented by formula (6) are used alone or in combination.

The lamellar oxide positive electrode active material that is the oxide represented by formula (7) is not particularly limited. For example, oxides represented by formula (7a):

LiMn_{1-v-w}CoᵥNi_{w}O₂ (7a)

wherein 0.1≦v≦0.4, and 0.1≦w≦0.8, are preferable.

The lamellar oxide represented by formula (7a) is not particularly limited, and examples thereof include LiMn_{1/3}Co_{1/3}Ni_{1/3}O₂, LiMn_{0.1}Co_{0.1}Ni_{0.8}O₂, and LiMn_{0.3}Cu_{0.2}Ni_{0.5}O₂. By use of such a compound represented by formula (7), stability tends to be enhanced. These compounds represented by formula (7) are used alone or in combination.

The composite lamellar oxide that is the complex oxide represented by formula (8) is not particularly limited. For example, complex oxides represented by formula (8a):

zLi₂MnO₃-(1-z)LiNiₐMn_{b}Co_{c}O₂ (8a)

wherein 0.3≦z≦0.7, a+b+c=1, 0.2≦a≦0.6, 0.2≦b≦0.6, and 0.05≦c≦0.4,
are preferable.

Among these, in formula (8a), the complex oxide in which 0.4≦z≦0.6, a+b+c=1, 0.3≦a≦0.4, 0.3≦b≦0.4, and 0.2≦c≦0.3 is more preferable. By use of such a complex oxide represented by formula (8), stability tends to be enhanced. These complex oxides represented by formula (8) are used alone or in combination.

The olivine type positive electrode active material that is the compound represented by formula (9) is not particularly limited. For example, compounds represented by formula (9a):

LiMn_{1-y}Fe_{y}PO₄ (9a)

wherein 0.05≦y≦0.8,
and compounds represented by formula (9b):

LiCo_{1-y}Fe_{y}PO₄ (9b)

wherein 0.05≦y≦0.8,
are preferable.

By use of such a compound represented by formula (9), stability and electron conducting properties tend to be enhanced. These compounds represented by formula (9) are used alone or in combination.

The fluorinated olivine type positive electrode active material that is the compound represented by formula (10) is not particularly limited. For example, Li₂FePO₄F, Li₂MnPO₄F, and Li₂CoPO₄F are preferable. By use of such a compound represented by formula (10), stability tends to be enhanced. These compounds represented by formula (10) are used alone or in combination.

These positive electrode active materials having a discharge capacity of 10 mAh/g or more at a potential of 4.4 V (vsLi/Li⁺) or more can be used alone or in combination. Alternatively, as the positive electrode active material, the positive electrode active material having a discharge capacity of 10 mAh/g or more at a potential of 4.4 V (vsLi/Li⁺) or more can also be used in combination with a positive electrode active material having no discharge capacity of 10 mAh/g or more at a potential of 4.4 V (vsLi/Li⁺) or more. The positive electrode active material having no discharge capacity of 10 mAh/g or more at a potential of 4.4 V (vsLi/Li⁺) or more is not particularly limited, and examples thereof include LiFePO₄.

### (Positive Electrode Potential Versus Lithium in Fully Charged Battery)

The potential of the positive electrode versus lithium in the fully charged lithium ion secondary battery according to the present embodiment is preferably 4.4 V (vsLi/Li⁺) or more, more preferably 4.45 V (vsLi/Li⁺) or more, and still more preferably 4.5 V (vsLi/Li⁺) or more. At a potential of the positive electrode in the fully charged battery of 4.4 V (vsLi/Li⁺) or more, the charge and discharge capacity of the positive electrode active material comprised in the lithium ion secondary battery tends to be utilized efficiently. At a potential of the positive electrode in the fully charged battery of 4.4 V (vsLi/Li⁺) or more, the energy density of the lithium ion secondary battery tends to be further improved. The potential of the positive electrode versus lithium in the fully charged battery can be controlled by controlling the voltage in the fully charged battery.

The potential of the positive electrode versus lithium in the fully charged battery can be easily measured as follows. The fully charged lithium ion secondary battery is disassembled inside of an Ar glovebox, and the positive electrode is extracted from the battery. The positive electrode and metal lithium used as a counter electrode are assembled into another battery, and the voltage is measured. In the case where a carbon negative electrode active material is used for the negative electrode, the carbon negative electrode active material in the fully charged battery has a potential of 0.05 V (vsLi/Li⁺). Then, the potential of the positive electrode in the fully charged battery can be easily calculated by adding 0.05 V to the voltage (Va) in the fully charged lithium ion secondary battery. For example, in the case where in the lithium ion secondary battery using a carbon negative electrode active material for the negative electrode, the fully charged lithium ion secondary battery has a voltage (Va) of 4.4 V, the potential of the positive electrode in the full charged battery is 4.4 V+0.05 V=4.45 V according to the calculation.

In the conventional lithium ion secondary battery, the potential of the positive electrode in the fully charged battery is usually set at 4.2 V (vsLi/Li⁺) to 4.3 V (vsLi/Li⁺) or less. Thus, the lithium ion secondary battery has a potential of the positive electrode in the fully charged battery of 4.4 V (vsLi/Li⁺) or more, and has a higher voltage than that of the conventional lithium ion secondary battery. In the present embodiment, the “high voltage lithium ion secondary battery” designates a lithium ion secondary battery that comprises a positive electrode having a positive electrode active material having a discharge capacity of 10 mAh/g or more at a potential of 4.4 V (vsLi/Li⁺) or more, and is used at a potential of the positive electrode in the fully charged battery of 4.4 V (vsLi/Li⁺) or more. The applications of such a high voltage lithium ion secondary battery may cause the problem in that the carbonate solvent contained in the electrolytic solution decomposes by oxidation on the surface of the positive electrode to reduce the cycle life of the battery. Such a problem is hardly found in the application of the conventional lithium ion secondary battery used at a potential of the positive electrode in the fully charged battery less than 4.4 V (vsLi/Li⁺). The lithium ion secondary battery according to the present embodiment having the configuration above can solve the problem that will arise at a potential of the positive electrode in the fully charged battery of 4.4 V (vsLi/Li⁺) or more, attaining operation at a high voltage and a high cycle life. (vsLi/Li⁺) designates the potential versus lithium.

### (Method of Producing Positive Electrode Active Material)

The positive electrode active material can be produced by the same method as the typical method of producing an inorganic oxide. The method of producing a positive electrode active material is not particularly limited, and examples thereof include a method in which metal salts (such as a sulfuric acid salt and/or a nitric acid salt) are mixed in a predetermined proportion to prepare a mixture, and the mixture is burned under an atmosphere environment containing oxygen to obtain a positive electrode active material containing an inorganic oxide. Another examples thereof include a method in which a carbonic acid salt and/or a hydroxide salt acts with a solution in which a metal salt is dissolved, thereby to deposit a poorly soluble metal salt; the poorly soluble metal salt is extracted and separated, and mixed with lithium carbonate and/or lithium hydroxide as a source of lithium; then, the mixture is burned under an atmosphere environment containing oxygen to obtain a positive electrode active material containing an inorganic oxide.

### (Method of Producing Positive Electrode)

Here, one example of the method of producing a positive electrode will be described below. First, a conductive aid, a binder, and the like are mixed with the positive electrode active material when necessary to prepare a positive electrode mixing agent, and the positive electrode mixing agent is dispersed in a solvent to prepare a paste containing the positive electrode mixing agent. Next, the paste is applied onto a positive electrode current collector, and dried to form a positive electrode mixing agent layer. Pressure is applied to the positive electrode mixing agent layer when necessary to adjust the thickness of the layer. Thus, a positive electrode can be produced.

The positive electrode current collector is not particularly limited, and examples thereof include those formed of metal foils such as aluminum foils or stainless steel foils.

### [Negative Electrode]

The lithium ion secondary battery according to the present embodiment includes a negative electrode. The negative electrode is not particularly limited as long as it acts as a negative electrode for the lithium ion secondary battery, and known negative electrodes can be used. Preferably, the negative electrode contains one or more selected from the group consisting of materials that can intercalate and deintercalate lithium ions as the negative electrode active material. Such a negative electrode active material is not particularly limited, and examples thereof include one or more selected from the group consisting of negative electrode active materials containing an element that can form an alloy with lithium such as carbon negative electrode active materials, silicon alloy negative electrode active materials, and tin alloy negative electrode active materials; silicon oxide negative electrode active materials; tin oxide negative electrode active materials; and lithium containing compounds such as lithium titanate negative electrode active materials. These negative electrode active materials are used alone or in combination.

The carbon negative electrode active material is not particularly limited, and examples thereof include hard carbon, soft carbon, artificial graphite, natural graphite, graphite, pyrolytic carbon, coke, glassy carbon, burned substances of organic high-molecular compounds, mesocarbon microbeads, carbon fibers, activated carbon, graphite, carbon colloid, and carbon black. Coke is not particularly limited, and examples thereof include pitch coke, needle coke, and petroleum coke. The burned substances of organic high-molecular compounds are not particularly limited, and examples thereof include polymer materials such as phenol resins and fran resins burned at a proper temperature into carbon.

The negative electrode active material containing an element that can form an alloy with lithium is not particularly limited, and may be a single substance of a metal or metalloid, or may be an alloy or a compound. Such a negative electrode active material may at least partially have one or two or more of these phases. The “alloy” includes those formed of two or more metal elements and those having one or more metal elements and one or more metalloid elements. The alloy may contain a non-metal element if the entire alloy has metal properties.

The metal elements and metalloid elements are not particularly limited, and examples thereof include titanium (Ti), tin (Sn), lead (Pb), aluminum (Al), indium (In), silicon (Si), zinc (Zn), antimony (Sb), bismuth (Bi), gallium (Ga), germanium (Ge), arsenic (As), silver (Ag), hafnium (Hf), zirconium (Zr), and yttrium (Y). Among these, Group 4 or Group 14 metal elements and metalloid elements in the long form of the periodic table are preferable, and titanium, silicon, and tin are particularly preferable.

### (Method of Producing Negative Electrode)

The negative electrode is obtained, for example, as follows. First, a conductive aid, a binder, and the like are mixed with the negative electrode active material when necessary to prepare a negative electrode mixing agent, and the negative electrode mixing agent is dispersed in a solvent to prepare a paste containing the negative electrode mixing agent. Next, the paste is applied onto a negative electrode current collector, and dried to form a negative electrode mixing agent layer. Pressure is applied to the negative electrode mixing agent layer when necessary to adjust the thickness of the layer. Thus, a negative electrode can be produced.

The negative electrode current collector is not particularly limited, and examples thereof include those formed of metal foils such as copper foils, nickel foils, or stainless steel foils.

The conductive aid used when necessary in the production of the positive electrode and the negative electrode is not particularly limited, and examples thereof include carbon black such as graphite, acetylene black, and ketjen black, and carbon fibers.

The binder used when necessary in the production of the positive electrode and the negative electrode is not particularly limited, and examples thereof include polyvinylidene fluoride (PVDF), polytetrafluoroethylene (PTFE), polyacrylic acid, styrene butadiene rubber, and fluorine rubber.

### [Separator]

The lithium ion secondary battery according to the present embodiment preferably comprises a separator between the positive electrode and the negative electrode from the viewpoint of preventing short circuits of the positive negative electrodes and giving safety such as shutdown. The separator is not particularly limited. For example, the same as those comprised in known lithium ion secondary batteries can be used. Among these, an insulating thin film having high ion permeability and mechanical strength is preferable.

The separator is not particularly limited, and examples thereof include woven fabrics, non-woven fabrics, and synthetic resin microporous membranes. Among these, synthetic resin microporous membranes are preferable. The non-woven fabrics are not particularly limited, and examples thereof include porous membranes formed of heat-resistant resins such as ceramics, polyolefins, polyesters, polyamides, liquid crystal polyesters, and aramides. Further, the synthetic resin microporous membranes are not particularly limited, and examples thereof include microporous membranes containing polyethylene or polypropylene as the main component or polyolefin microporous membranes such as microporous membranes containing these polyolefins. The separator may be a single layer or multi layer of one microporous membrane, or may be a layer of two or more microporous membranes.

The lithium ion secondary battery according to the present embodiment is not particularly limited. For example, the lithium ion secondary battery according to the present embodiment comprises a separator, a positive electrode and a negative electrode between which the separator is interposed, a positive electrode current collector (disposed on the outer side of the positive electrode) and a negative electrode current collector (disposed on the outer side of the negative electrode) between which the laminate is interposed, and a battery exterior that accommodates these members. The laminate of the positive electrode, the separator, and the negative electrode is impregnated with the electrolytic solution according to the present embodiment.

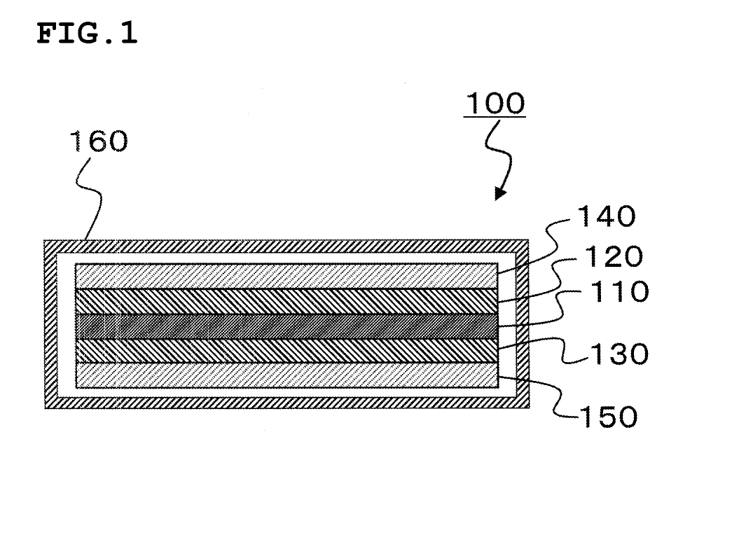

FIG. 1 is a sectional view schematically showing an example of the lithium ion secondary battery according to the present embodiment. A lithium ion secondary battery 100 shown in FIG. 1 includes a separator 110, a positive electrode 120 and a negative electrode 130 between which the separator 110 is interposed, a positive electrode current collector 140 (disposed on the outer side of the positive electrode) and a negative electrode current collector 150 (disposed on the outer side of the negative electrode) between which the laminate is interposed, and a battery exterior 160 that accommodates these members. The laminate of the positive electrode 120, the separator 110, and the negative electrode 130 is impregnated with the electrolytic solution.

### [Method of Producing Lithium Ion Secondary Battery]

The lithium ion secondary battery according to the present embodiment can be produced by a known method using the electrolytic solution, the positive electrode, the negative electrode, and when necessary the separator. For example, the positive electrode, the separator, and the negative electrode are layered with the separator interposed therebetween, and wound into a laminate having a winding structure or folded, or several layers of these three members are laminated, for example, to mold a laminate formed of sets of the positive electrode and negative electrode alternatively disposed with the separator interposed therebetween. Next, the laminate is accommodated inside of a battery casing (exterior body). Then, the electrolytic solution according to the present embodiment is charged into the casing to impregnate the laminate with the electrolytic solution, and the casing is sealed. Thereby, a lithium ion secondary battery can be produced. The shape of the lithium ion secondary battery according to the present embodiment is not particularly limited. For example, cylindrical shapes, oval shapes, prism shapes, button shapes, coin shapes, flat shapes, and laminate shapes are suitably used, for example.

### EXAMPLES

Hereinafter, the present invention will be more specifically described using Examples and Comparative Examples. The present invention will not be limited by Examples below.

### (1) Evaluation of Battery Performance of Lithium Ion Secondary Battery Using LiNi_{0.5}Mn_{1.5}O₄ Positive Electrode

### <Synthesis of Positive Electrode Active Material>

Nickel sulfate and manganese sulfate in a molar ratio of 1:3 in terms of the transition metal elements were dissolved in water to prepare a nickel-manganese mixed aqueous solution such that the total of the metal ion concentration was 2 mol/L. Next, the nickel-manganese mixed aqueous solution was dropped into 1650 mL of a 2 mol/L sodium carbonate aqueous solution heated to 70° C. at an addition rate of 12.5 mL/min for 120 minutes. During dropping, under stirring, air at a flow rate of 200 mL/min was blown into the aqueous solution while air was being bubbled. Thereby, a precipitate was produced. The obtained precipitate was sufficiently washed with distilled water, and dried to obtain a nickel manganese compound. The obtained nickel manganese compound and lithium carbonate having a particle diameter of 2 μm were weighed such that the molar ratio of lithium:nickel:manganese was 1:0.5:1.5, and dry mixed for 1 hour. Then, the obtained mixture was burned under an oxygen atmosphere at 1000° C. for 5 hours to obtain a positive electrode active material represented by LiNi_{0.5}Mn_{1.5}O₄.

### <Production of Positive Electrode Sheet>

The thus-obtained positive electrode active material, a graphite powder (made by TIMCAL Ltd., trade name “KS-6”) and an acetylene black powder (made by DENKI KAGAKU KOGYO KABUSHIKI KAISHA, trade name “HS-100”) as the conductive aid, and a polyvinylidene fluoride solution (made by KUREHA CORPORATION, trade name “L#7208”) as the binder were mixed in a mass ratio of the solid contents of 80:5:5:10. N-methyl-2-pyrrolidone as a disperse solvent was added to the obtained mixture such that the solid contents was 35% by mass, and mixed therewith to prepare a slurry solution. The slurry solution was applied onto one surface of an aluminum foil having a thickness of 20 μm, and the solvent was dried and removed. Then, the obtained product was rolled with a roll press to obtain a positive electrode sheet.

The thus-obtained positive electrode and a negative electrode formed of metal Li were used to produce a half cell using an electrolytic solution comprising a mixed solvent of ethylene carbonate and ethylmethyl carbonate in a volume ratio of 1:2 and 1 mol/L of LiPF₆ salt. The half cell was charged at 0.02 C to 4.85 V, and discharged at 0.1 C. Thus, it was found that the positive electrode active material had a discharge capacity of 111 mAh/g at a potential of 4.4 V (vsLi/Li⁺) or more.

### <Production of Negative Electrode Sheet>

A graphite powder (made by Osaka Gas Chemicals Co., Ltd., trade name “OMAC1.2H/SS”) and another graphite powder (made by TIMCAL Ltd., trade name “SFG6”) as the negative electrode active material, styrene butadiene rubber (SBR) as the binder and a carboxymethyl cellulose aqueous solution were mixed in a mass ratio of solid contents of 90:10:1.5:1.8. The obtained mixture was added to water as a disperse solvent such that the concentration of the solid contents was 45% by mass, to prepare a slurry solution. The slurry solution was applied onto one surface of a copper foil having a thickness of 18 μm, and the solvent was dried and removed. Then, the obtained product was rolled with a roll press to obtain a negative electrode sheet.

### <Production of Battery>

The thus-produced positive electrode sheet and negative electrode sheet each were punched into a disk having a diameter of 16 mm to obtain a positive electrode and a negative electrode. The obtained positive electrode was layered on one side of a separator formed of a polypropylene microporous membrane (film thickness: 25 μm, porosity: 50%, pore diameter: 0.1 μm to 1 μm) and the negative electrode was layered on the other side of the separator to form a laminate. The laminate was inserted into a disk type battery casing (exterior body) made of stainless steel. Next, 0.2 mL of the electrolytic solution described in Examples below was injected into the casing to impregnate the laminate with the electrolytic solution. The battery casing was sealed to produce a lithium ion secondary battery.

### <Evaluation of Battery Performance>

The obtained lithium ion secondary battery was accommodated in a thermostat (made by Futaba Kagaku K.K., trade name “PLM-73S”) set at 25° C. The battery was connected to a charge and discharge apparatus (made by ASKA Electronic Co., Ltd., trade name “ACD-01”), and left as it was for 20 hours. Next, the battery was charged at 0.2 C at a constant current to 4.9 V, charged at a constant voltage of 4.9 V for 8 hours, and discharged at a constant current of 0.2 C to 3.0 V. Such a charge and discharge operation was repeated three times.

After the initial charge and discharge operation above, in the thermostat set at 50° C., the battery was charged at a constant current of 1.0 C to 4.9 V, charged at a constant voltage of 4.9 V for 2 hours, and discharged at a constant current of 1.0 C to 3.0 V. This series of charge and discharge operation was defined as one cycle, and further 29 cycles of the charge and discharge operation were repeated. In total, 30 cycles of the cycle charge and discharge were performed. At the first cycle and the 30th cycle, the discharge capacity per mass of the positive electrode active material was checked. The discharge capacity at the 30th cycle was divided by the discharge capacity at the first cycle to calculate the discharge capacity retention rate.

### (2) Evaluation of Gas Generation in Lithium Ion Secondary Battery Using LiNi_{0.5}Mn_{1.5}O₄ Positive Electrode

The positive electrode sheet and negative electrode sheet produced in the same manner as in (1) above were punched into a rectangular shape. The obtained positive electrode was layered on one side of a separator formed of a polypropylene microporous membrane (film thickness: 25 μm, porosity: 50%, pore diameter: 0.1 μm to 1 μm) and the negative electrode was layered on the other side of the separator to form a laminate. The laminate was inserted into a bag formed of a laminate film prepared by coating both surfaces of an aluminum foil (thickness: 40 μm) with a resin layer, with the terminals of the positive and negative electrodes being projected. Then, 0.5 mL of the electrolytic solution described in Examples below was injected into the bag. The bag was vacuum sealed to produce a sheet-like lithium ion secondary battery.

The obtained sheet-like lithium ion secondary battery was accommodated in a thermostat (made by Futaba Kagaku K.K., trade name “PLM-73S”) set at 25° C. The battery was connected to a charge and discharge apparatus (made by ASKA Electronic Co., Ltd., trade name “ACD-01”), and left as it was for 20 hours. Next, the battery was charged at 0.2 C at a constant current to 4.9 V, charged at a constant voltage of 4.9 V for 8 hours, and discharged at a constant current of 0.2 C to 3.0 V. Such a charge and discharge operation was repeated three times.

After the initial charge and discharge operation above, the battery was immersed in a water bath to measure the volume. Then, under a 50° C. environment, the battery was charged at a constant current of 1 C to a voltage of 4.9 V, continuously charged at a constant voltage of 4.9 V for 9 days, and discharged at a constant current of 1 C to 3.0 V. The battery was cooled to room temperature, and immersed in a water bath to measure the volume. From the difference between the volume of the battery before and that after the continuous charge, the amount of the gas to be generated after the operation of the battery (mL) was determined.

### Example 1

0.05 g of lithium bis(oxalato)borate represented by formula (11) (made by Rockwood Lithium GmbH, hereinafter written as “LiBOB”) and 0.05 g of tris(trimethylsilyl)phosphate (PO₄(Si (CH₃)₃)₃, made by Sigma-Aldrich Corporation, 275794) were added to 9.85 g of a solution (made by KISHIDA CHEMICAL Co., Ltd., LBG00069) comprising a mixed solvent of ethylene carbonate and ethylmethyl carbonate in a volume ratio of 1:2 and 1 mol/L of LiPF₆ salt. Thus, an electrolytic solution A was prepared. The content of LiBOB in the electrolytic solution A was 0.5% by mass, the content of tris(trimethylsilyl) phosphate was 0.5% by mass, and the content of LiPF₆ was 13% by mass.

A lithium ion secondary battery was produced by the method described in (1) above using the electrolytic solution A, and the battery performance was evaluated. The lithium ion secondary battery containing the electrolytic solution A had a high discharge capacity at the first cycle of 118 mAh/g, and a high discharge capacity at the 30th cycle of 88 mAh/g, and a high discharge capacity retention rate of 75%. The discharge capacity retention rate was obtained by dividing the discharge capacity at the 30th cycle by the discharge capacity at the first cycle. The lithium ion secondary battery according to the present Example was charged to 4.9 V, and disassembled inside of an Ar glovebox. The positive electrode was extracted from the battery. The positive electrode and metal lithium used as a counter electrode were assembled into another battery, and the potential of the positive electrode was measured. The potential was 4.95 V (vsLi/Li⁺).

A sheet-like lithium ion secondary battery was produced by the method described in (2) above using the electrolytic solution A, and gas generation was evaluated. The amount of the gas to be generated after the operation of the battery was small as 2.63 mL.

### Example 2

0.05 g of LiBOB and 0.1 g of tris(trimethylsilyl)phosphate were added to 9.85 g of a solution comprising a mixed solvent of ethylene carbonate and ethylmethyl carbonate in a volume ratio of 1:2 and 1 mol/L of LiPF₆ salt to obtain an electrolytic solution B. The content of LiBOB in the electrolytic solution B was 0.5% by mass, the content of tris(trimethylsilyl)phosphate was 1.0% by mass, and the content of LiPF₆ was 13% by mass.

The battery performance of the lithium ion secondary battery containing the electrolytic solution B was evaluated in the same manner as in Example 1 by the method described in (1) above. As a result, the battery had a high discharge capacity at the first cycle of 117 mAh/g, a high discharge capacity at the 30th cycle of 93 mAh/g, and a high discharge capacity retention rate of 79%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 1.89 mL.

### Example 3

0.05 g of LiBOB and 0.2 g of tris(trimethylsilyl)phosphate were added to 9.75 g of a solution comprising a mixed solvent of ethylene carbonate and ethylmethyl carbonate in a volume ratio of 1:2 and 1 mol/L of LiPF₆ salt to obtain an electrolytic solution C. The content of LiBOB in the electrolytic solution C was 0.5% by mass, the content of tris(trimethylsilyl)phosphate was 2.0% by mass, and the content of LiPF₆ was 13% by mass.

The battery performance of the lithium ion secondary battery containing the electrolytic solution C was evaluated in the same manner as in Example 1 by the method described in (1) above. As a result, the battery had a high discharge capacity at the first cycle of 117 mAh/g, a high discharge capacity at the 30th cycle of 95 mAh/g, and a high discharge capacity retention rate of 81%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 1.56 mL.

### Example 4

Under a nitrogen stream, 10.9 g of chlorotrimethylsilane (made by Sigma-Aldrich Corporation, 386529) was gradually added to 3.3 g of potassium pyrophosphate (made by Sigma-Aldrich Corporation, 322431) The mixture was stirred at 60° C. for 8 hours. Under a nitrogen atmosphere, the solid component was removed by filtration, and the volatile component was removed under reduced pressure to obtain 2.3 g of tetrakis(trimethylsilyl)pyrophosphate (P₂O₇(Si(CH₃)₃)₄). The structure of the compound was identified by NMR. A peak existed at −30 ppm(s) in ³¹P-NMR and at 1.54 ppm(s) in ¹H-NMR.

0.05 g of LiBOB and 0.2 g of tetrakis(trimethylsilyl)pyrophosphate obtained by the synthesis were added to 9.75 g of a solution comprising a mixed solvent of ethylene carbonate and ethylmethyl carbonate in a volume ratio of 1:2 and 1 mol/L of LiPF₆ salt to obtain an electrolytic solution D. The content of LiBOB in the electrolytic solution D was 0.5% by mass, the content of tetrakis(trimethylsilyl)pyrophosphate was 2.0% by mass, and the content of LiPF₆ was 13% by mass.

The battery performance of the lithium ion secondary battery containing the electrolytic solution D was evaluated in the same manner as in Example 1 by the method described in (1) above. As a result, the battery had a high discharge capacity at the first cycle of 115 mAh/g, a high discharge capacity at the 30th cycle of 92 mAh/g, and a high discharge capacity retention rate of 80%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.45 mL.

### Example 5

0.05 g of LiBOB and 0.05 g of trimethylsilyl polyphosphate (made by Sigma-Aldrich Corporation, 414026) were added to 9.9 g of a solution comprising a mixed solvent of ethylene carbonate and ethylmethyl carbonate in a volume ratio of 1:2 and 1 mol/L of LiPF₆ salt to obtain an electrolytic solution E. The content of LiBOB in the electrolytic solution E was 0.5% by mass, the content of trimethylsilyl polyphosphate was 0.5% by mass, and the content of LiPF₆ was 13% by mass.

The battery performance of the lithium ion secondary battery containing the electrolytic solution E was evaluated in the same manner as in Example 1 by the method described in (1) above. As a result, the battery had a high discharge capacity at the first cycle of 109 mAh/g, a high discharge capacity at the 30th cycle of 81 mAh/g, and a high discharge capacity retention rate of 74%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.19 mL.

### Example 6

0.05 g of LiBOB and 0.05 g of tris(trimethylsilyl)phosphite (PO₃(Si(CH₃)₃)₃, made by Sigma-Aldrich Corporation, 93412) were added to 9.9 g of a solution comprising a mixed solvent of ethylene carbonate and ethylmethyl carbonate in a volume ratio of 1:2 and 1 mol/L of LiPF₆ salt to obtain an electrolytic solution F. The content of LiBOB in the electrolytic solution F was 0.5% by mass, the content of tris(trimethylsilyl)phosphite was 0.5% by mass, and the content of LiPF₆ was 13% by mass.

The battery performance of the lithium ion secondary battery containing the electrolytic solution F was evaluated in the same manner as in Example 1 by the method described in (1) above. As a result, the battery had a high discharge capacity at the first cycle of 113 mAh/g, a high discharge capacity at the 30th cycle of 85 mAh/g, and a high discharge capacity retention rate of 75%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.71 mL.

### Example 7

0.05 g of LiBOB and 0.2 g of tris(trimethylsilyl)phosphite were added to 9.75 g of a solution comprising a mixed solvent of ethylene carbonate and ethylmethyl carbonate in a volume ratio of 1:2 and 1 mol/L of LiPF₆ salt to obtain an electrolytic solution G. The content of LiBOB in the electrolytic solution G was 0.5% by mass, the content of tris(trimethylsilyl)phosphite was 2% by mass, and the content of LiPF₆ was 13% by mass.

The battery performance of the lithium ion secondary battery containing the electrolytic solution G was evaluated in the same manner as in Example 1 by the method described in (1) above. As a result, the battery had a high discharge capacity at the first cycle of 113 mAh/g, a high discharge capacity at the 30th cycle of 90 mAh/g, and a high discharge capacity retention rate of 80%. The discharge capacity retention rate was obtained by dividing the discharge capacity at the 30th cycle by the discharge capacity at the first cycle.

### Example 8

0.05 g of LiBOB and 0.05 g of bis(trimethylsilyl)adipate (C₆H₁₀O₄(Si (CH₃)₃)₂, made by Gelest, Inc.) were added to 9.9 g of a solution comprising a mixed solvent of ethylene carbonate and ethylmethyl carbonate in a volume ratio of 1:2 and 1 mol/L of LiPF₆ salt to obtain an electrolytic solution H. The content of LiBOB in the electrolytic solution H was 0.5% by mass, the content of bis(trimethylsilyl)adipate was 0.5% by mass, and the content of LiPF₆ was 13% by mass.

The battery performance of the lithium ion secondary battery containing the electrolytic solution H was evaluated in the same manner as in Example 1 by the method described in (1) above. As a result, the battery had a high discharge capacity at the first cycle of 114 mAh/g, a high discharge capacity at the 30th cycle of 85 mAh/g, and a high discharge capacity retention rate of 75%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 3.01 mL.

### Example 9

0.05 g of LiBOB and 0.2 g of bis(trimethylsilyl)adipate were added to 9.75 g of a solution comprising a mixed solvent of ethylene carbonate and ethylmethyl carbonate in a volume ratio of 1:2 and 1 mol/L of LiPF₆ salt to obtain an electrolytic solution I. The content of LiBOB in the electrolytic solution I was 0.5% by mass, the content of bis(trimethylsilyl)adipate was 2% by mass, and the content of LiPF₆ was 13% by mass.

The battery performance of the lithium ion secondary battery containing the electrolytic solution I was evaluated in the same manner as in Example 1 by the method described in (1) above. As a result, the battery had a high discharge capacity at the first cycle of 113 mAh/g, a high discharge capacity at the 30th cycle of 87 mAh/g, and a high discharge capacity retention rate of 77%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.45 mL.

### Example 10

0.05 g of LiBOB and 0.05 g of tris(trimethylsilyl)borate (BO₃(Si(CH₃)₃)₃, made by Sigma-Aldrich Corporation, 348635) were added to 9.9 g of a solution comprising a mixed solvent of ethylene carbonate and ethylmethyl carbonate in a volume ratio of 1:2 and 1 mol/L of LiPF₆ salt to obtain an electrolytic solution J. The content of LiBOB in the electrolytic solution J was 0.5% by mass, the content of tris(trimethylsilyl)borate was 0.5% by mass, and the content of LiPF₆ was 13% by mass.

The battery performance of the lithium ion secondary battery containing the electrolytic solution J was evaluated in the same manner as in Example 1 by the method described in (1) above. As a result, the battery had a high discharge capacity at the first cycle of 109 mAh/g, a high discharge capacity at the 30th cycle of 88 mAh/g, and a high discharge capacity retention rate of 81%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.97 mL.

### Example 11

0.15 g of LiBOB and 0.05 g of tris(trimethylsilyl)phosphate were added to 9.8 g of a solution comprising a mixed solvent of ethylene carbonate and ethylmethyl carbonate in a volume ratio of 1:2 and 1 mol/L of LiPF₆ salt to obtain an electrolytic solution K. The content of LiBOB in the electrolytic solution K was 1.5% by mass, the content of tris(trimethylsilyl)phosphate was 0.5% by mass, and the content of LiPF₆ was 13% by mass.

The battery performance of the lithium ion secondary battery containing the electrolytic solution K was evaluated in the same manner as in Example 1 by the method described in (1) above. As a result, the battery had a high discharge capacity at the first cycle of 116 mAh/g, a high discharge capacity at the 30th cycle of 100 mAh/g, and a high discharge capacity retention rate of 86%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.76 mL.

### Example 12

0.05 g of LiBF₄ (made by KISHIDA CHEMICAL Co., Ltd., LBG44852) and 0.05 g of tris(trimethylsilyl)phosphate were added to 9.9 g of a solution comprising a mixed solvent of ethylene carbonate and ethylmethyl carbonate in a volume ratio of 1:2 and 1 mol/L of LiPF₆ salt to obtain an electrolytic solution L. The content of LiBF₄ in the electrolytic solution L was 0.5% by mass, the content of tris(trimethylsilyl)phosphate was 0.5% by mass, and the content of LiPF₆ was 13% by mass.

The battery performance of the lithium ion secondary battery containing the electrolytic solution L was evaluated in the same manner as in Example 1 by the method described in (1) above. As a result, the battery had a high discharge capacity at the first cycle of 113 mAh/g, a high discharge capacity at the 30th cycle of 82 mAh/g, and a high discharge capacity retention rate of 73%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.38 mL.

### Example 13

Under a nitrogen stream, 5.0 g of lithium oxalate (made by Sigma-Aldrich Corporation, O0130) was gradually added to 35 g of a boron trifluoride diethylether complex (made by Wako Pure Chemical Industries, Ltd., 022-08362) cooled with ice. After the temperature was raised to room temperature, the solution was stirred at 80° C. for 19 hours, and a solid was deposited. The non-reacted boron trifluoride diethylether complex was removed, dimethyl carbonate was poured, and the insoluble solid was filtered out. The volatile component was removed under reduced pressure, and recrystallization was performed with dimethyl carbonate/hexane. The obtained crystal was vacuum dried at 80° C. for 12 hours to obtain 6.8 g of LiBF₂(C₂O₄) represented by formula (13). The structure of the compound was identified by NMR. A peak existed at 3.55 ppm(t) in ¹¹B-NMR, at 150.2 ppm(m) in ¹⁹F-NMR, and 160 ppm(s) in ¹³C-NMR.

0.05 g of LiBF₂(C₂O₄) obtained by the synthesis and 0.05 g of tris(trimethylsilyl)phosphate were added to 9.9 g of a solution comprising a mixed solvent of ethylene carbonate and ethylmethyl carbonate in a volume ratio of 1:2 and 1 mol/L of LiPF₆ salt to obtain an electrolytic solution M. The content of LiBF₂(C₂O₄) in the electrolytic solution M was 0.5% by mass, the content of tris(trimethylsilyl)phosphate was 0.5% by mass, and the content of LiPF₆ was 13% by mass.

The battery performance of the lithium ion secondary battery containing the electrolytic solution M was evaluated in the same manner as in Example 1 by the method described in (1) above. As a result, the battery had a high discharge capacity at the first cycle of 117 mAh/g, a high discharge capacity at the 30th cycle of 87 mAh/g, and a high discharge capacity retention rate of 74%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.43 mL.

### Example 14

0.05 g of LiBOB, 0.05 g of tris(trimethylsilyl)phosphate, and 0.01 g of lithium difluorophosphate were added to 9.89 g of a solution comprising a mixed solvent of ethylene carbonate and ethylmethyl carbonate in a volume ratio of 1:2 and 1 mol/L of LiPF₆ salt to obtain an electrolytic solution N. The content of LiBOB in the electrolytic solution N was 0.5% by mass, the content of tris(trimethylsilyl)phosphate was 0.5% by mass, the content of lithium difluorophosphate was 0.1% by mass, and the content of LiPF₆ was 13% by mass.

The battery performance of the lithium ion secondary battery containing the electrolytic solution N was evaluated in the same manner as in Example 1 by the method described in (1) above. As a result, the battery had a high discharge capacity at the first cycle of 115 mAh/g, a high discharge capacity at the 30th cycle of 91 mAh/g, and a high discharge capacity retention rate of 79%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.61 mL.

### Example 15

0.05 g of LiBF₂(C₂O₄), 0.05 g of tris(trimethylsilyl)phosphate, and 0.01 g of lithium difluorophosphate were added to 9.89 g of a solution comprising a mixed solvent of ethylene carbonate and ethylmethyl carbonate in a volume ratio of 1:2 and 1 mol/L of LiPF₆ salt to obtain an electrolytic solution O. The content of LiBF₂(C₂O₄) in the electrolytic solution O was 0.5% by mass, the content of tris(trimethylsilyl)phosphate was 0.5% by mass, the content of lithium difluorophosphate was 0.1% by mass, and the content of LiPF₆ was 13% by mass.

The battery performance of the lithium ion secondary battery containing the electrolytic solution O was evaluated in the same manner as in Example 1 by the method described in (1) above. As a result, the battery had a high discharge capacity at the first cycle of 112 mAh/g, a high discharge capacity at the 30th cycle of 90 mAh/g, and a high discharge capacity retention rate of 80%. The discharge capacity retention rate was obtained by dividing the discharge capacity at the 30th cycle by the discharge capacity at the first cycle.

### Example 16

0.05 g of LiBOB, 0.05 g of bis(trimethylsilyl)adipate, and 0.01 g of lithium difluorophosphate were added to 9.89 g of a solution comprising a mixed solvent of ethylene carbonate and ethylmethyl carbonate in a volume ratio of 1:2 and 1 mol/L of LiPF₆ salt to obtain an electrolytic solution P. The content of LiBOB in the electrolytic solution P was 0.5% by mass, the content of bis(trimethylsilyl)adipate was 0.5% by mass, the content of lithium difluorophosphate was 0.1% by mass, and the content of LiPF₆ was 13% by mass.

The battery performance of the lithium ion secondary battery containing the electrolytic solution P was evaluated in the same manner as in Example 1 by the method described in (1) above. As a result, the battery had a high discharge capacity at the first cycle of 111 mAh/g, a high discharge capacity at the 30th cycle of 89 mAh/g, and a high discharge capacity retention rate of 80%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was small as 2.89 mL.

### Comparative Example 1

A solution comprising a mixed solvent of ethylene carbonate and ethylmethyl carbonate in a volume ratio of 1:2 and 1 mol/L of LiPF₆ salt was used as an electrolytic solution Q. The content of LiPF₆ in the electrolytic solution Q was 13% by mass.

The battery performance of the lithium ion secondary battery containing the electrolytic solution Q was evaluated in the same manner as in Example 1 by the method described in (1) above. As a result, the battery had a discharge capacity at the first cycle of 107 mAh/g, a discharge capacity at the 30th cycle of 63 mAh/g, and a discharge capacity retention rate of 59%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was 4.72 mL.

### Comparative Example 2

0.05 g of tris(trimethylsilyl)phosphate was added to 9.95 g of a solution comprising a mixed solvent of ethylene carbonate and ethylmethyl carbonate in a volume ratio of 1:2 and 1 mol/L of LiPF₆ salt to obtain an electrolytic solution R. The content of tris(trimethylsilyl)phosphate in the electrolytic solution R was 0.5% by mass, and the content of LiPF₆ was 13% by mass.

The battery performance of the lithium ion secondary battery containing the electrolytic solution R was evaluated in the same manner as in Example 1 by the method described in (1) above. As a result, the battery had a discharge capacity at the first cycle of 114 mAh/g, a discharge capacity at the 30th cycle of 71 mAh/g, and a discharge capacity retention rate of 62%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was 2.58 mL.

### Comparative Example 3

0.05 g of bis(trimethylsilyl)adipate was added to 9.95 g of a solution comprising a mixed solvent of ethylene carbonate and ethylmethyl carbonate in a volume ratio of 1:2 and 1 mol/L of LiPF₆ salt to obtain an electrolytic solution S. The content of bis(trimethylsilyl)adipate in the electrolytic solution S was 0.5% by mass, and the content of LiPF₆ was 13% by mass.

The battery performance of the lithium ion secondary battery containing the electrolytic solution S was evaluated in the same manner as in Example 1 by the method described in (1) above. As a result, the battery had a discharge capacity at the first cycle of 113 mAh/g, a discharge capacity at the 30th cycle of 72 mAh/g, and a discharge capacity retention rate of 64%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was 3.12 mL.

### Comparative Example 4

0.05 g of LiBOB was added to 9.95 g of a solution comprising a mixed solvent of ethylene carbonate and ethylmethyl carbonate in a volume ratio of 1:2 and 1 mol/L of LiPF₆ salt to obtain an electrolytic solution T. The content of LiBOB in the electrolytic solution T was 0.5% by mass, and the content of LiPF₆ was 13% by mass.

The battery performance of the lithium ion secondary battery containing the electrolytic solution T was evaluated in the same manner as in Example 1 by the method described in (1) above. As a result, the battery had a discharge capacity at the first cycle of 116 mAh/g, a discharge capacity at the 30th cycle of 78 mAh/g, and a discharge capacity retention rate of 67%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was 4.12 mL.

### Comparative Example 5

0.05 g of LiBOB and 0.05 g of trimethyl phosphate (PO₄(CH₃)₃, made by Sigma-Aldrich Corporation, 241024) were added to 9.9 g of a solution comprising a mixed solvent of ethylene carbonate and ethylmethyl carbonate in a volume ratio of 1:2 and 1 mol/L of LiPF₆ salt to obtain an electrolytic solution U. The content of LiBOB in the electrolytic solution U was 0.5% by mass, the content of the trimethyl phosphate was 0.5%, and the content of LiPF₆ was 13% by mass.

The battery performance of the lithium ion secondary battery containing the electrolytic solution U was evaluated in the same manner as in Example 1 by the method described in (1) above. As a result, the battery had a discharge capacity at the first cycle of 115 mAh/g, a discharge capacity at the 30th cycle of 76 mAh/g, and a discharge capacity retention rate of 66%. The discharge capacity retention rate was obtained by dividing the discharge capacity at the 30th cycle by the discharge capacity at the first cycle.

The gas generation was evaluated by the method described in (2) above. The amount of the gas to be generated after the operation of the battery was 4.10 mL.

The results of evaluations in Examples 1 to 16 and Comparative Examples 1 to 5 are shown in Table 1. Apparently from Table 1, a combination of the specific boron containing lithium salt (B) and the specific compound (C) can attain high cycle performance and a high suppressing effect on the gas to be generated even in the lithium ion secondary battery using the positive electrode that operates at a high voltage of 4.95 V (vsLi/Li⁺).

### (3) Evaluation of Battery Performance of Lithium Ion Secondary Battery Using LiNi_{1/3}Mn_{1/3}Co_{1/3}O₂ Positive Electrode

Next, the results of evaluation of the battery performance using the LiNi_{1/3}Mn_{1/3}Co_{1/3}O₂ positive electrode are shown.

### <Production of Positive Electrode>

LiNi_{1/3}Mn_{1/3}Co_{1/3}O₂ (made by NIPPON CHEMICAL INDUSTRIAL CO., LTD.) as the positive electrode active material, an acetylene black powder (made by DENKI KAGAKU KOGYO KABUSHIKI KAISHA) as the conductive aid, and a polyvinylidene fluoride solution (made by KUREHA CORPORATION) as the binder were mixed in a mass ratio of solid contents of 90:6:4. N-methyl-2-pyrrolidone as the disperse solvent was further added thereto such that the solid contents was 40% by mass, and mixed to prepare a slurry solution. The slurry solution was applied onto one surface of an aluminum foil having a thickness of 20 μm, and the solvent was dried and removed. The obtained product was rolled with a roll press to produce a positive electrode. The product after rolling was punched into a disk having a diameter of 16 mm to obtain a positive electrode.

### <Production of Negative Electrode>

A graphite powder (made by Osaka Gas Chemicals Co., Ltd., trade name “OMAC1.2H/SS”) and another graphite powder (made by TIMCAL Ltd., trade name “SFG6”) as the negative electrode active material, styrene butadiene rubber (SBR) as the binder and a carboxymethyl cellulose aqueous solution were mixed in a mass ratio of solid contents of 90:10:1.5:1.8. The obtained mixture was added to water as the disperse solvent such that the concentration of the solid contents was 45% by mass, to prepare a slurry solution. The slurry solution was applied onto one surface of a copper foil having a thickness of 18 μm, and the solvent was dried and removed. The obtained product was rolled with a roll press. The product after rolling was punched into a disk having a diameter 16 mm to obtain a negative electrode.

### <Production of Battery>

The thus-produced positive electrode sheet and negative electrode sheet each were punched into a disk having a diameter of 16 mm to produce a positive electrode and a negative electrode. The obtained positive electrode was layered on one side of a separator formed of a polypropylene microporous membrane (film thickness: 25 μm, porosity: 50%, pore diameter: 0.1 μm to 1 μm) and the negative electrode was layered on the other side of the separator to form a laminate. The laminate was inserted into a disk type battery casing (exterior body) made of stainless steel. Next, 0.2 mL of the electrolytic solution described in Examples below was injected into the casing to impregnate the laminate with the electrolytic solution. Then, the battery casing was sealed to produce a lithium ion secondary battery.

### <Evaluation of Battery Performance>

The obtained lithium ion secondary battery was accommodated in a thermostat (made by Futaba Kagaku K.K., trade name “PLM-73S”) set at 25° C. The battery was connected to a charge and discharge apparatus (made by ASKA Electronic Co., Ltd., trade name “ACD-01”), and left as it was for 20 hours. Next, the battery was charged at a constant current of 0.2 C to 4.4 V, charged at a constant voltage of 4.4 V for 8 hours, and discharged at a constant current of 0.2 C to 3.0 V.

After the initial charge and discharge operation above, in the thermostat set at 50° C., the battery was charged at a constant current of 1.0 C to 4.4 V, and discharged at a constant current of 1.0 C to 3.0 V. This series of charge and discharge operation was defined as one cycle, and further 99 cycles of the charge and discharge operation were repeated. In total, 100 cycles of the cycle charge and discharge were performed. At the first cycle and the 100th cycle, the discharge capacity per mass of the positive electrode active material was checked. The discharge capacity at the 100th cycle was divided by the discharge capacity at the first cycle to calculate a discharge capacity retention rate.

### Example 17

A lithium ion secondary battery was produced by the method (3) above using the electrolytic solution A prepared in Example 1, and the battery performance was evaluated. The lithium ion secondary battery containing the electrolytic solution A had a high discharge capacity at the first cycle of 161 mAh/g, and a high discharge capacity at the 100th cycle of 125 mAh/g, and a high discharge capacity retention rate of 78%. The discharge capacity retention rate was obtained by dividing the discharge capacity at the 100th cycle by the discharge capacity at the first cycle. The lithium ion secondary battery according to the present Example was charged to 4.4 V, and disassembled inside of an Ar glovebox. The positive electrode was extracted from the battery. The positive electrode and metal lithium used as a counter electrode were assembled into another battery, and the potential of the positive electrode was measured. The potential was 4.45 V (vsLi/Li⁺).

### Example 18

The battery performance of the lithium ion secondary battery containing the electrolytic solution F produced in Example 6 was evaluated in the same manner as in Example 17 by the method (3) above. As a result, the battery had a high discharge capacity at the first cycle of 159 mAh/g, a high discharge capacity at the 100th cycle of 126 mAh/g, and a high discharge capacity retention rate of 79%. The discharge capacity retention rate was obtained by dividing the discharge capacity at the 100th cycle by the discharge capacity at the first cycle.

### Example 19

The battery performance of the lithium ion secondary battery containing the electrolytic solution H produced in Example 8 was evaluated in the same manner as in Example 17 by the method (3) above. As a result, the battery had a high discharge capacity at the first cycle of 157 mAh/g, a high discharge capacity at the 100th cycle of 122 mAh/g, and a high discharge capacity retention rate of 78%. The discharge capacity retention rate was obtained by dividing the discharge capacity at the 100th cycle by the discharge capacity at the first cycle.

### Example 20

The battery performance of the lithium ion secondary battery containing the electrolytic solution L produced in Example 12 was evaluated in the same manner as in Example 17 by the method (3) above. As a result, the battery had a high discharge capacity at the first cycle of 160 mAh/g, a high discharge capacity at the 100th cycle of 122 mAh/g, and a high discharge capacity retention rate of 76%. The discharge capacity retention rate was obtained by dividing the discharge capacity at the 100th cycle by the discharge capacity at the first cycle.

### Example 21

The battery performance of the lithium ion secondary battery containing the electrolytic solution M produced in Example 13 was evaluated in the same manner as in Example 17 by the method (3) above. As a result, the battery had a high discharge capacity at the first cycle of 161 mAh/g, a high discharge capacity at the 100th cycle of 124 mAh/g, and a high discharge capacity retention rate of 77%. The discharge capacity retention rate was obtained by dividing the discharge capacity at the 100th cycle by the discharge capacity at the first cycle.

### Example 22

The battery performance of the lithium ion secondary battery containing the electrolytic solution N produced in Example 14 was evaluated in the same manner as in Example 17 by the method (3) above. As a result, the battery had a high discharge capacity at the first cycle of 163 mAh/g, a high discharge capacity at the 100th cycle of 126 mAh/g, and a high discharge capacity retention rate of 77%. The discharge capacity retention rate was obtained by dividing the discharge capacity at the 100th cycle by the discharge capacity at the first cycle.

### Comparative Example 6

The battery performance of the lithium ion secondary battery containing the electrolytic solution Q produced in Comparative Example 1 was evaluated in the same manner as in Example 17 by the method (3) above. As a result, the battery had a discharge capacity at the first cycle of 157 mAh/g, a discharge capacity at the 100th cycle of 96 mAh/g, and a discharge capacity retention rate of 61%. The discharge capacity retention rate was obtained by dividing the discharge capacity at the 100th cycle by the discharge capacity at the first cycle.

### Comparative Example 7

The battery performance of the lithium ion secondary battery containing the electrolytic solution R produced in Comparative Example 2 was evaluated in the same manner as in Example 17 by the method (3) above. As a result, the battery had a discharge capacity at the first cycle of 160 mAh/g, a discharge capacity at the 100th cycle of 114 mAh/g, and a discharge capacity retention rate of 71%. The discharge capacity retention rate was obtained by dividing the discharge capacity at the 100th cycle by the discharge capacity at the first cycle.

### Comparative Example 8

The battery performance of the lithium ion secondary battery containing the electrolytic solution T produced in Comparative Example 4 was evaluated in the same manner as in Example 17 by the method (3) above. As a result, the battery had a discharge capacity at the first cycle of 159 mAh/g, a discharge capacity at the 100th cycle of 106 mAh/g, and a discharge capacity retention rate of 67%. The discharge capacity retention rate was obtained by dividing the discharge capacity at the 100th cycle by the discharge capacity at the first cycle.

### Comparative Example 9

The battery performance of the lithium ion secondary battery containing the electrolytic solution U produced in Comparative Example 5 was evaluated in the same manner as in Example 17 by the method (3) above. As a result, the battery had a discharge capacity at the first cycle of 157 mAh/g, a discharge capacity at the 100th cycle of 107 mAh/g, and a discharge capacity retention rate of 68%. The discharge capacity retention rate was obtained by dividing the discharge capacity at the 100th cycle by the discharge capacity at the first cycle.

The results of evaluation in Examples 17 to 22 and Comparative Examples 6 to 9 are shown in Table 2. Apparently from Table 2, a combination of the specific boron containing lithium salt (B) and the specific compound (C) can attain high cycle performance in the lithium ion secondary battery using the positive electrode that operates at a high voltage of 4.45 V (vsLi/Li⁺).

TABLE 1

| | | | | | | Evaluation of battery (1) | | |
|---|---|---|---|---|---|---|---|---|
| | | | | | | 30 cy | 30 cy | Evaluation of |
| | | | | | | discharge | retention | gas generated (2) |
| | Electrolytic | Lithium salt | Lithium salt | Compound | Another | capacity | rate | Gas generated |
| Example | solution | (A) | (B) | (C) | compound | (mAh/g) | (%) | (mL) |
| Example 1 | Electrolytic | LiPF₆ | LiBOB | Tris(trimethylsilyl) | — | 88 | 75% | 2.63 |
| | solution A | 13% | 0.5% | phosphate | | | | |
| | | | | 0.5% | | | | |
| Example 2 | Electrolytic | LiPF₆ | LiBOB | Tris(trimethylsilyl) | — | 93 | 79% | 1.89 |
| | solution B | 13% | 0.5% | phosphate | | | | |
| | | | | 1% | | | | |
| Example 3 | Electrolytic | LiPF₆ | LiBOB | Tris(trimethylsilyl) | — | 95 | 81% | 1.56 |
| | solution C | 13% | 0.5% | phosphate | | | | |
| | | | | 2% | | | | |
| Example 4 | Electrolytic | LiPF₆ | LiBOB | Tetrakis(trimethylsilyl) | — | 92 | 80% | 2.45 |
| | solution D | 13% | 0.5% | pyrophosphate | | | | |
| | | | | 2% | | | | |
| Example 5 | Electrolytic | LiPF₆ | LiBOB | Trimethylsilyl | — | 81 | 74% | 2.19 |
| | solution E | 13% | 0.5% | polyphosphate | | | | |
| | | | | 0.5% | | | | |
| Example 6 | Electrolytic | LiPF₆ | LiBOB | Tris(trimethylsilyl) | — | 85 | 75% | 2.71 |
| | solution F | 13% | 0.5% | phosphite | | | | |
| | | | | 0.5% | | | | |
| Example 7 | Electrolytic | LiPF₆ | LiBOB | Tris(trimethylsilyl) | — | 90 | 80% | — |
| | solution G | 13% | 0.5% | phosphite | | | | |
| | | | | 2% | | | | |
| Example 8 | Electrolytic | LiPF₆ | LiBOB | Bis(trimethylsilyl) | — | 85 | 75% | 3.01 |
| | solution H | 13% | 0.5% | adipate | | | | |
| | | | | 0.5% | | | | |
| Example 9 | Electrolytic | LiPF₆ | LiBOB | Bis(trimethylsilyl) | — | 87 | 77% | 2.45 |
| | solution I | 13% | 0.5% | adipate | | | | |
| | | | | 2% | | | | |
| Example 10 | Electrolytic | LiPF₆ | LiBOB | Tris(trimethylsilyl) | — | 88 | 81% | 2.97 |
| | solution J | 13% | 0.5% | borate | | | | |
| | | | | 0.5% | | | | |
| Example 11 | Electrolytic | LiPF₆ | LiBOB | Tris(trimethylsilyl) | — | 100 | 86% | 2.76 |
| | solution K | 13% | 1.5% | phosphate | | | | |
| | | | | 0.5% | | | | |
| Example 12 | Electrolytic | LiPF₆ | LiBF₄ | Tris(trimethylsilyl) | — | 82 | 73% | 2.38 |
| | solution L | 13% | 0.5% | phosphate | | | | |
| | | | | 0.5% | | | | |
| Example 13 | Electrolytic | LiPF₆ | LiBF₂(C₂O₄) | Tris(trimethylsilyl) | — | 87 | 74% | 2.43 |
| | solution M | 13% | 0.5% | phosphate | | | | |
| | | | | 0.5% | | | | |
| Example 14 | Electrolytic | LiPF₆ | LiBOB | Tris(trimethylsilyl) | Li | 91 | 79% | 2.61 |
| | solution N | 13% | 0.5% | phosphate | difluorophosphate | | | |
| | | | | 0.5% | 0.1% | | | |
| Example 15 | Electrolytic | LiPF₆ | LiBF₂(C₂O₄) | Tris(trimethylsilyl) | Li | 90 | 80% | — |
| | solution O | 13% | 0.5% | phosphate | difluorophosphate | | | |
| | | | | 0.5% | 0.1% | | | |
| Example 16 | Electrolytic | LiPF₆ | LiBOB | Bis(trimethylsilyl) | Li | 89 | 80% | 2.89 |
| | solution P | 13% | 0.5% | adipate | difluorophosphate | | | |
| | | | | 0.5% | 0.1% | | | |
| Comparative | Electrolytic | LiPF₆ | — | — | — | 63 | 59% | 4.72 |
| Example1 | solution Q | 13% | | | | | | |
| Comparative | Electrolytic | LiPF₆ | — | Tris(trimethylsilyl) | — | 71 | 62% | 2.58 |
| Example2 | solution R | 13% | | phosphate | | | | |
| | | | | 0.5% | | | | |
| Comparative | Electrolytic | LiPF₆ | — | Bis(trimethylsilyl) | — | 72 | 64% | 3.12 |
| Example3 | solution S | 13% | | adipate | | | | |
| | | | | 0.5% | | | | |
| Comparative | Electrolytic | LiPF₆ | LiBOB | — | — | 78 | 67% | 4.12 |
| Example4 | solution T | 13% | 0.5% | | | | | |
| Comparative | Electrolytic | LiPF₆ | LiBOB | Trimethyl phosphate | — | 76 | 66% | 4.10 |
| Example5 | solution U | 13% | 0.5% | 0.5% | | | | |

TABLE 2

| | | | | | | Evaluation of battery (3) | |
|---|---|---|---|---|---|---|---|
| | | | | | | 100 cy | 100 cy |
| | | | | | | discharge | retention |
| | Electrolytic | Lithium salt | Lithium salt | Compound | Another | capacity | rate |
| Example | solution | (A) | (B) | (C) | compound | (mAh/g) | (%) |
| Example 17 | Electrolytic | LiPF₆ | LiBOB | Tris(trimethylsilyl) | — | 125 | 78% |
| | solution A | 13% | 0.5% | phosphate | | | |
| | | | | 0.5% | | | |
| Example 18 | Electrolytic | LiPF₆ | LiBOB | Tris(trimethylsilyl) | — | 126 | 79% |
| | solution F | 13% | 0.5% | phosphite | | | |
| | | | | 0.5% | | | |
| Example 19 | Electrolytic | LiPF₆ | LiBOB | Bis(trimethylsilyl) | — | 122 | 78% |
| | solution H | 13% | 0.5% | adipate | | | |
| | | | | 0.5% | | | |
| Example 20 | Electrolytic | LiPF₆ | LiBF₄ | Tris(trimethylsilyl) | — | 122 | 76% |
| | solution L | 13% | 0.5% | phosphate | | | |
| | | | | 0.5% | | | |
| Example 21 | Electrolytic | LiPF₆ | LiBF₂ | Tris(trimethylsilyl) | — | 124 | 77% |
| | solution M | 13% | (C₂O₄) | phosphate | | | |
| | | | 0.5% | 0.5% | | | |
| Example 22 | Electrolytic | LiPF₆ | LiBOB | Tris(trimethylsilyl) | Li | 126 | 77% |
| | solution N | 13% | 0.5% | phosphate | difluorophosphate | | |
| | | | | 0.5% | 0.1% | | |
| Comparative | Electrolytic | LiPF₆ | — | — | — | 96 | 61% |
| Example 6 | solution Q | 13% | | | | | |
| Comparative | Electrolytic | LiPF₆ | — | Tris(trimethylsilyl) | — | 114 | 71% |
| Example 7 | solution R | 13% | | phosphate | | | |
| | | | | 0.5% | | | |
| Comparative | Electrolytic | LiPF₆ | LiBOB | — | — | 106 | 67% |
| Example 8 | solution T | 13% | 0.5% | | | | |
| Comparative | Electrolytic | LiPF₆ | LiBOB | Trimethyl phosphate | — | 107 | 68% |
| Example 9 | solution U | 13% | 0.5% | 0.5% | | | |

The electrolytic solution for the non-aqueous energy storage device according to the present invention, and the lithium ion secondary battery using the electrolytic solution have industrial applicability to a variety of power supplies for consumer apparatuses and automobile power supplies.

What is claimed is:

1. An electrolytic solution for a non-aqueous energy storage device, comprising:
a non-aqueous solvent;
a lithium salt (A) having no boron atom;
a lithium salt (B) containing a boron atom represented by formula (1), formula (2), or a combination thereof: 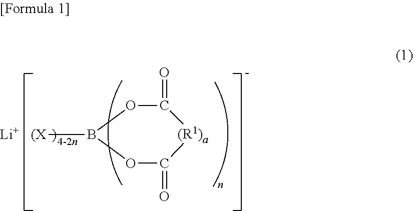
wherein X each independently represents a halogen atom selected from the group consisting of a fluorine atom, a chlorine atom, and a bromine atom; R¹ each independently represents a hydrocarbon group which has 1 to 10 carbon atoms and which may have a substituent; a represents an integer of 0 or 1; and n represents an integer of 0 to 2; 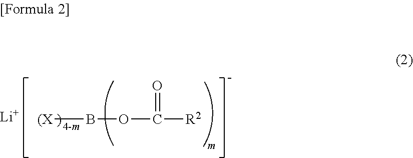
wherein X each independently represents a halogen atom selected from the group consisting of a fluorine atom, a chlorine atom, and a bromine atom; R² each independently represents a hydrogen atom, a fluorine atom, or a hydrocarbon group which has 1 to 10 carbon atoms and which may have a substituent; and m represents an integer of 0 to 4; and
a compound (C) in which at least one of hydrogen atoms in an acid selected from the group consisting of proton acids having a phosphorus atom and/or a boron atom, sulfonic acids, silicic acids and carboxylic acids is replaced with a substituent represented by formula (3): 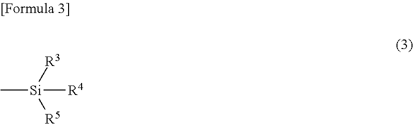
wherein R³, R⁴, and R⁵ each independently represent an organic group which has 1 to 10 carbon atoms and which may have a substituent.

2. The electrolytic solution for the non-aqueous energy storage device according to claim 1,
wherein the compound (C) comprises a compound represented by formula (4): 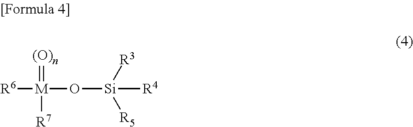
wherein M represents a phosphorus atom or a boron atom; n is 0 or 1 when M is a phosphorus atom; n is 0 when M is a boron atom; R³, R⁴, and R⁵ each independently represent an organic group which has 1 to 10 carbon atoms and which may have a substituent; and R⁶ and R⁷ each independently represent a group selected from the group consisting of an OH group, an OLi group, an alkyl group which has 1 to 10 carbon atoms and which may have a substituent, an alkoxy group which has 1 to 10 carbon atoms and which may have a substituent, a siloxy group having 3 to 10 carbon atoms, an aryl group having 6 to 15 carbon atoms, and an aryloxy group having 6 to 15 carbon atoms;
and/or a compound represented by formula (5): 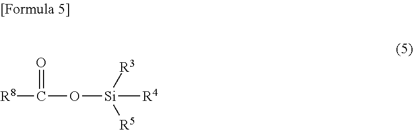
wherein R³, R⁴, and R⁵ each independently represent an organic group which has 1 to 10 carbon atoms and which may have a substituent; and R⁸ represents an organic group which has 1 to 20 carbon atoms and which may have a substituent.

3. The electrolytic solution for the non-aqueous energy storage device according to claim 1 or 2,
wherein a content of the lithium salt (A) is 1% by mass or more and 40% by mass or less based on 100% by mass of the electrolytic solution for the non-aqueous energy storage device,
a content of the lithium salt (B) is 0.01% by mass or more and 10% by mass or less based on 100% by mass of the electrolytic solution for the non-aqueous energy storage device, and
a content of the compound (C) is 0.01% by mass or more and 10% by mass or less based on 100% by mass of the electrolytic solution for the non-aqueous energy storage device.

4. The electrolytic solution for the non-aqueous energy storage device according to claim 1 or 2,
wherein the lithium salt (B) is one or more selected from the group consisting of LiBF₄, LiB(C₂O₄)₂, and LiBF₂(C₂O₄).

5. The electrolytic solution for the non-aqueous energy storage device according to claim 1 or 2,
wherein the lithium salt (A) comprises LiPF₆.

6. The electrolytic solution for the non-aqueous energy storage device according to claim 1 or 2,
further comprising one or more lithium salts selected from the group consisting of lithium difluorophosphate and lithium monofluorophosphate.

7. The electrolytic solution for the non-aqueous energy storage device according to claim 1 or 2,
wherein the non-aqueous solvent comprises a cyclic carbonate and a linear carbonate.

8. The electrolytic solution for the non-aqueous energy storage device according to claim 7,
wherein the cyclic carbonate comprises one or more selected from the group consisting of ethylene carbonate and propylene carbonate, and
the linear carbonate comprises one or more selected from the group consisting of dimethyl carbonate, diethyl carbonate, and ethylmethyl carbonate.

9. A lithium ion secondary battery, comprising:
a positive electrode having a positive electrode active material,
a negative electrode having a negative electrode active material, and
the electrolytic solution for the non-aqueous energy storage device according to claim 1 or 2.

10. The lithium ion secondary battery according to claim 9,
wherein the positive electrode active material has a discharge capacity of 10 mAh/g or more at a potential of 4.4 V (vsLi/Li⁺) or more.

11. The lithium ion secondary battery according to claim 9,
wherein the positive electrode active material is one or more selected from the group consisting of:
oxides represented by formula (6):
LiMn₂₋ₓMaₓO₄ (6)
wherein Ma represents one or more selected from the group consisting of transition metals; and x is 0.2≦x≦0.7;
oxides represented by formula (7):
LiMn₁₋ᵤMeᵤO₂ (7)
wherein Me represents one or more selected from the group consisting of transition metals except Mn; and u is 0.11≦u≦0.9;
complex oxides represented by formula (8):
zLi₂McO₃-(1-z)LiMdO₂ (8)
wherein Mc and Md each independently represent one or more selected from the group consisting of transition metals; and z is 0.1≦z≦0.9;
compounds represented by formula (9):
LiMb_{1-y}Fe_{y}PO₄ (9)
wherein Mb represents one or more selected from the group consisting of Mn and Co; and y is 0≦y≦0.9; and
compounds represented by formula (10):
Li₂MfPO₄F (10)
wherein Mf represents one or more selected from the group consisting of transition metals.

12. The lithium ion secondary battery according to claim 9,
wherein a potential of the positive electrode versus lithium in a fully charged battery is 4.4 V (vsLi/Li⁺) or more.
